(19) United States
(12) Patent Application Publication
(10) Pub. No.: US 2017/0308034 A1
(43) Pub. Date: Oct. 26, 2017

(54) IMAGE FORMING APPARATUS

(71) Applicant: CANON KABUSHIKI KAISHA, Tokyo (JP)

(72) Inventor: Hiroki Katayama, Suntou-gun (JP)

(21) Appl. No.: 15/493,518

(22) Filed: Apr. 21, 2017

(30) Foreign Application Priority Data
Apr. 22, 2016 (JP) 2016-085650

(51) Int. Cl. G03G 21/18

(52) U.S. Cl. CPC G03G 21/185

(57) ABSTRACT

An image forming apparatus includes a casing; a process unit for forming a developer image on a sheet; an image exposing unit; a sheet cassette detachably mounted to the casing; a feeding roller for single the sheet from the cassette; a feeding guide provided in the casing and configured to guide the sheet moving from the cassette to the process unit. The exposing unit is disposed right above the feeding roller. The process unit is at a position the same position as the exposing unit in the vertical direction and downstream of the exposing unit in a horizontal direction. The cassette is below the feeding roller. The guide is between the exposing unit and the cassette in the vertical direction. The guide includes upper and lower guides. When the cassette is drawn out of the casing, the lower guide moves to an accommodating portion in the cassette.

### FIELD OF THE INVENTION AND RELATED ART

The present invention relates to an image forming apparatus such as a copying machine, a printing machine, a facsimileing machine, etc.

In recent years, it has come to be desired to reduce an image forming apparatus in size so that the apparatus can be set up in various locations. In the case of the image forming apparatus disclosed in Japanese Laid-open Patent Application No. 2015-036761, it is regulated in the positioning of each of its various units. More specifically, the image forming apparatus comprises: a processing unit having a photosensitive member, an exposing unit for exposing the photosensitive member, and a fixing unit for fixing an image formed of developer on a sheet of recording medium, such as paper, with the use of the photosensitive member, to the sheet. These units are disposed directly above the recording medium feeding-conveying cassette, in which multiple sheets of recording medium are stored. Further, they are roughly horizontally disposed, in order to reduce the apparatus in dimension in terms of height.

It sometimes occurs that a sheet of recording medium gets stuck (which hereafter may be referred to as “jammed”) in an image forming apparatus, and therefore, it becomes impossible for a sheet of recording medium to be conveyed through the apparatus. If a sheet of recording medium becomes jammed in an image forming apparatus, the jammed sheet of recording medium has be removed by a user him- or herself. Therefore, a structural arrangement for an image forming apparatus, which can make it easier for a user to remove the jammed sheet of recording medium in the apparatus, has been desired.

One of such structural arrangements for an image forming apparatus, which can make it easier for a user to remove a jammed sheet of recording medium in an image forming apparatus is disclosed in Japanese Laid-open Patent Application No. 2007-197162. According to this patent application, the image forming apparatus is structured so that its recording medium conveyance guide, which is a part of the recording medium conveyance passage, is movable. More specifically, it is structured so that as a sheet of recording medium becomes jammed in the straight portion of the recording medium conveyance passage, through which a sheet of recording medium is conveyed when an image is to be formed on the second surface of the sheet, its recording medium feeding-conveying cassette, in which multiple sheets of recording medium are stored, can be pulled out to remove the jammed sheet. Further, it is structured so that as the cassette is pulled out of the main assembly of the apparatus, a bottom guide, which is a part of the recording medium conveyance passage of the apparatus, is moved into the portion of the cassette, which is reserved for the bottom guide, in order to make it easier for a user to access the recording medium conveyance passage to remove the jammed sheet of recording medium.

However, in the case of the image forming apparatus disclosed in Japanese Laid-open Patent Application No. 2015-036761, as a sheet of recording medium is fed from within the recording medium feeding-conveying cassette into the main assembly of the image forming apparatus, the sheet is made to move through a bent portion of the recording medium passage, and then, is moved through the straight portion of the recording medium passage, which is between the cassette and each unit. Further, the exposing unit is disposed directly above the recording medium passage. Therefore, it is impossible for a user to access the recording medium passage from the top side of the passage to remove the jammed sheet of recording medium.

In the case of the image forming apparatus, disclosed in Japanese Laid-open Patent Application No. 2007-197162, which is structured so that a user can easily access the recording medium passage from the top side of the passage, the bottom conveyance guide, which is a part of the straight portion of the recording medium passage, moves into the portion of the interior of the recording medium feeding-conveying cassette, which is dedicated to the bottom conveyance guide. Thus, from the standpoint of the accessibility by a user to the bent portion of the recording medium conveyance passage, this apparatus is not as satisfactory as the one disclosed in Japanese Laid-open Patent Application No. 2015-036761. Thus, this apparatus is not satisfactory in that a user cannot access the recording medium conveyance passage from the bottom side of the passage to remove the jammed sheet of recording medium.

### SUMMARY OF THE INVENTION

The present invention was made to solve the above-described problem. Thus, its primary object is to provide an image forming apparatus which is superior to any conventional image forming apparatus, in terms of how easily a jammed sheet of recording medium in the main assembly of the apparatus can be removed.

According to an aspect of the present invention, there is provided an image forming apparatus comprising a casing; a process unit detachably mounted to said casing, configured to form a developer image on a recording material and including a photosensitive member extending in a direction crossing with a vertical direction; an exposing unit configured to expose said photosensitive member to light; a cassette detachably mounted to said casing configured to accommodate the recording material to be fed to said process unit; a feeding rotatable member configured to separate and feeding a single recording material from said cassette; and a feeding guide provided in said casing and configured to guide the recording material moving from said cassette to said process unit, wherein said exposing unit is disposed right above said feeding rotatable member in the vertical direction, said process unit is disposed at a position which is substantially the same as said exposing unit in the vertical direction and which is downstream of said exposing unit in a horizontal direction, with respect to a feeding direction of the recording material, said cassette is disposed below said feeding rotatable member in the vertical direction, and said feeding guide is disposed between said exposing unit and said cassette in the vertical direction, wherein said feeding guide includes an upper guide configured to guide an upper surface of the recording material and a lower guide configured to guide a lower surface of the recording material, and wherein when said cassette is drawn out of said casing, said lower guide moves to an accommodating portion in said cassette.

Further features of the present invention will become apparent from the following description of exemplary embodiments with reference to the attached drawings.

### BRIEF DESCRIPTION OF THE DRAWINGS

FIG. 1 is a sectional view of a typical image forming apparatus to which the present invention is applicable. It shows the general structure of the apparatus.

FIG. 2 is an exploded perspective of the recording medium feeding-conveying portion of the image forming apparatus in the first embodiment of the present invention, as seen from the top side of the recording medium feeding-conveying portion, when the recording medium feeding-conveying cassette is in its preset recording medium feeding-conveying position in the casing of the apparatus. It shows the structure of the means for rotationally moving the bottom guide of the recording medium conveyance passage of the apparatus.

FIG. 3 is an exploded perspective of the recording medium feeding-conveying portion of the image forming apparatus in the first embodiment of the present invention, as seen from the bottom side of the recording medium feeding-conveying portion, when the recording medium feeding-conveying cassette is in its preset recording medium feeding-conveying position in the casing of the apparatus. It shows the structure of the means for rotationally moving the bottom guide of the recording medium conveyance passage of the apparatus.

FIG. 4 is a top view of the bottom guide moving means in the first embodiment, when the bottom guide is in its normal position (recording medium guiding position). It shows the structure of the bottom guide moving means.

FIG. 5 is a sectional view of a combination of the recording medium feeding-conveying cassette and recording medium feeding-conveying portion, in the first embodiment, at a vertical plane A-A in FIG. 4, when the bottom guide is in its normal position (recording medium guiding position).

FIG. 6 is a sectional view of the combination of the recording medium feeding-conveying cassette and recording medium feeding-conveying portion, in the first embodiment, at the vertical plane A-A in FIG. 4, when the bottom guide is about to be rotationally moved (retracted) from its normal position (recording medium guiding position) into its retraction position.

FIG. 7 is a sectional view of the combination of the recording medium feeding-conveying cassette and recording medium feeding-conveying portion in the first embodiment, at the vertical plane A-A in FIG. 4, when the bottom guide is being rotationally retracted from its normal position (recording medium guiding position).

FIG. 8 is a sectional view of the combination of the recording medium feeding-conveying cassette and recording medium feeding-conveying portion in the first embodiment, at the vertical plane A-A in FIG. 4, when the bottom guide is in its retracted state.

FIG. 9 is an exploded perspective of a combination of the recording medium feeding-conveying cassette and recording medium feeding-conveying portion of the image forming apparatus in the second embodiment of the present invention, as seen from the top side of the recording medium feeding-conveying portion, when the recording medium feeding-conveying cassette is in its preset position (recording medium feeding position) in the casing of the apparatus. It shows the structure of the means for rotationally moving the bottom guide of the recording medium conveyance passage of the apparatus.

FIG. 10 is an exploded perspective of the combination of the recording medium feeding-conveying cassette and recording medium feeding-conveying portion of the image forming apparatus in the second embodiment of the present invention, as seen from the top side of the recording medium feeding-conveying portion, when the recording medium feeding-conveying cassette is in its preset position (recording medium feeding position) in the casing of the apparatus. It shows the structure of the means for rotationally moving the bottom guide of the recording medium conveyance passage of the apparatus.

FIG. 11 is a top view of the combination of the recording medium feeding-conveying cassette and recording medium feeding-conveying portion in the second embodiment, when the bottom guide is in its normal position (recording medium guiding position). It shows the structure of the bottom guide moving means.

FIG. 12 is a sectional view of the combination of the recording medium feeding-conveying cassette and recording medium feeding-conveying portion in the second embodiment, at a vertical plane B-B in FIG. 11, when the bottom guide is in its normal position (recording medium guiding position).

FIG. 13 is a perspective view of the bottom guide moving means, as seen from the top side of the means, when the bottom guide is ready to be rotationally moved from its recording medium feeding-conveying position to its retraction position.

FIG. 14 is a sectional view of the recording medium feeding-conveying portion in the second embodiment, at the vertical plane B-B in FIG. 11, when the bottom guide is about to rotationally retract from its normal position (recording medium guiding position).

FIG. 15 is an exploded perspective view of a combination of the recording medium feeding-conveying cassette and recording medium feeding-conveying portion in the third embodiment of the present invention, as seen from the top side of the recording medium feeding-conveying portion, when the cassette is in its preset position (recording medium feeding position) in the main assembly of an image forming apparatus. It shows the structure of the bottom guide moving means.

FIG. 16 is an exploded perspective view of the combination of the recording medium feeding-conveying cassette and recording medium feeding-conveying portion in the third embodiment of the present invention, as seen from the bottom side of the cassette, when the cassette is in its preset position (recording medium feeding position) in the main assembly of an image forming apparatus. It shows the structure of the bottom guide moving means.

FIG. 17 is a top view of the combination of the recording medium feeding-conveying cassette and recording medium feeding-conveying portion in the third embodiment, when the bottom guide is in its retreat. It shows the structure of the bottom guide moving means.

FIG. 18 is a sectional view of the combination of the recording medium feeding-conveying portion and recording medium feeding-conveying cassette of the image forming apparatus in the third embodiment, at a plane C-C in FIG. 17, when the bottom guide is in its retreat.

### DESCRIPTION OF THE EMBODIMENTS

Next, the present invention is concretely described with reference to the image forming apparatus in the first embodiment of the present invention, with reference to drawings.

### Embodiment 1

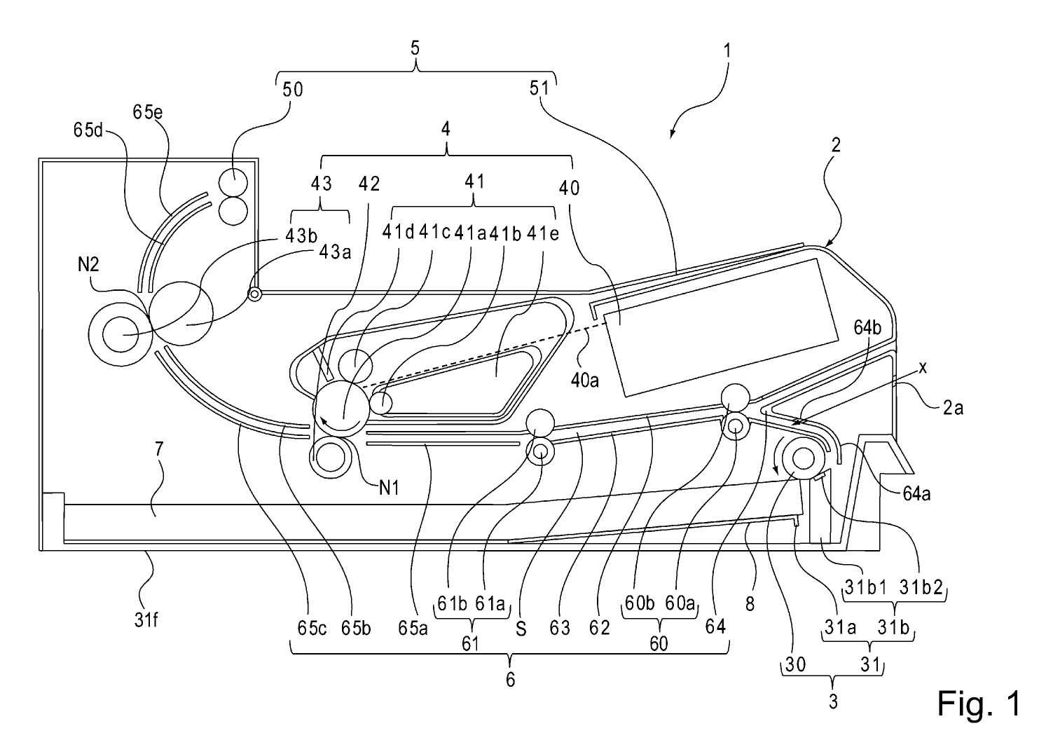

To begin with, referring to FIGS. 1-8, the image forming apparatus in the first embodiment of the present invention is described about its structure. The image forming apparatus shown in FIG. 1 is a laser beam printer. It is one of the examples of an image forming apparatus to which the present invention was applied. Regarding the orientation of the image forming apparatus in the following description of the apparatus, provided that the image forming apparatus shown in FIG. 1 is disposed on the horizontal surface, the right side of the image forming apparatus in FIG. 1 is the front side of the apparatus, and the left side of the apparatus is the rear side of the apparatus. Further, the front side of a sheet of paper on which FIG. 1 is drawn, coincides with the left side of the image forming apparatus 1, and the rear side of the sheet coincides with the right side of the image forming apparatus 1.

### <Image Forming Apparatus>

The image forming apparatus 1 shown in FIG. 1 has a recording medium feeding-conveying portion 6 (which hereafter may be referred to simply as “conveying portion 6”), an image forming portion 4, and a discharging portion 5, which are supported by the casing 2 of the main assembly of the image forming apparatus 1. Further, the image forming apparatus 1 is provided with a recording medium feeding-conveying portion 3 (which hereafter will be referred to as “feeding-conveying portion 3”), which is installed into, or uninstalled from, the casing 2 of the main assembly of the image forming apparatus 1. Further, the casing 2 is provided with a slit 2a, through which ambient light is allowed to enter the casing 2 in the direction indicated by an arrow mark X in FIG. 1.

### <Feeding-Conveying Portion>

The feeding-conveying portion 3 is provided with a recording medium feeding-conveying cassette 31 (which hereafter may be referred to simply as “cassette 31), which is removably installable in the bottom portion of the casing 2. It is also provided with a feed roller 30, which is a rotational member which feeds sheets 7 of recording medium such as paper stored in the cassette 31, one by one into the conveying portion 6. More specifically, the sheets 7 of recording medium stored in the cassette 31 are fed into the main assembly of the image forming apparatus 1 one by one, by the feed roller 30 while being separated from each other by the coordination between the feed roller 30 and a separation pad 31b2. After being fed into the main assembly by the feeding-conveying portion 3, each sheet 7 of recording medium is conveyed to the image forming portion 4 by the conveying portion 6.

### <Cassette>

The cassette 31 is provided with a lift 31a which causes a middle plate 8 on which sheets 7 of recording medium are mounted in layers, to move up or down, and a separating portion 31b which separates sheets 7 in coordination with the feed roller 30. The separating portion 31b is provided with the separation pad 31b2 which separates the sheets 7 one by one by being pressed against the feed roller 30, and a separation pad holder 31b1 which supports the separation pad 31b2. In terms of the vertical direction (upward and downward direction in FIG. 1), the cassette 31 is disposed on the bottom side of the feed roller 30 (sheet feeding-conveying rotational member).

The sheet feeding portion 3 is disposed in the feeding-conveying cassette 31. It lifts the sheets 7 of recording medium loaded in layers on the middle plate 8 to keep the sheets 7 pressed upon the feeding-conveying roller 30. As the feeding-conveying roller 30 is rotated in the counterclockwise direction in FIG. 1, the sheets 7 are moved out of the feeding-conveying roller 30 from the cassette 31 while being separated from each other. Then, each sheet 7 of recording medium is conveyed from the feeding-conveying portion 3 to the conveying portion 6. Then, the sheet 7 is supplied to a process cartridge 41 (processing unit) by the conveying portion 6.

### <Separating Portion>

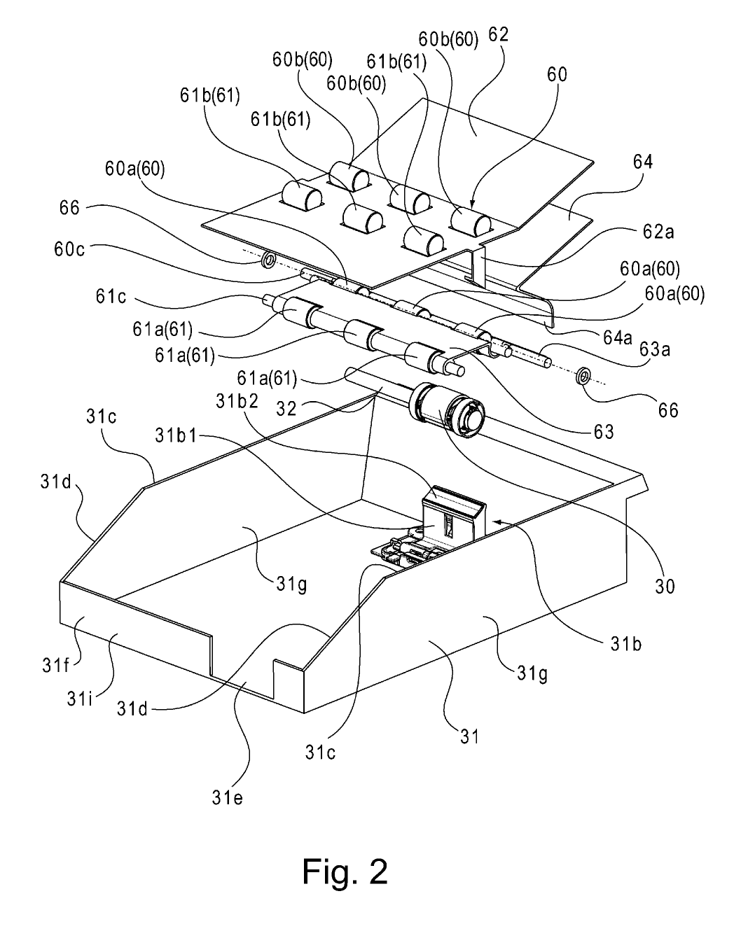

Referring to FIG. 2, the separating portion 31b is fixed to the bottom plate 31f of the feeding-conveying cassette 31. It feeds the sheets 7 of recording medium one by one into the main assembly of the image forming apparatus 1 while separating the sheets 7 from each other by the coordination of the separation pad 31b2 supported by the separation pad holder 31b1, and the feeding-conveying roller 30. The rotational shaft 60c of a conveyance roller 60a shown in FIG. 2, and the rotational shaft 61b of the registration roller 61a are rotatably supported by their lengthwise ends, by the casing 2. They are rotationally driven by an unshown motor which functions as a driving force source.

The conveyance roller 60a and registration roller 61a rotate together about their rotational shafts 60c and 61c, respectively. The conveyance roller 60b and registration roller 61b are disposed in a manner to oppose the conveyance roller 60a and registration roller 61a, and are kept pressed upon the conveyance roller 60a and registration roller 61a, respectively, by unshown compression springs which function as pressing means. Thus, each sheet 7 of recording medium is pinched by the pair of conveyance rollers 60 and pair of registration roller 61. Therefore, as the conveyance roller 60a and registration roller 61a are rotated, the sheet 7 is conveyed to the image forming portion 4.

### <Image Forming Portion>

The image forming portion 4 shown in FIG. 1 has: a laser scanner unit 40 (exposing unit) which is an exposing means; and the process cartridge 41 (processing unit) which is removably installable in the casing 2 of the main assembly of the image forming apparatus 1. Further, the image forming portion 4 has: a transfer roller 42 which is a transferring means; and a fixing apparatus 43 which is a fixing means. The image forming portion 4 forms a toner image on a sheet 7 of recording medium, based on the information of an image to be formed.

### <Exposing Unit>

Referring to FIG. 1, in terms of the vertical direction (upward-downward direction in FIG. 1), the laser scanner unit 40 which is an exposing unit is disposed directly above the feeding-conveying roller 30 (rotational feeding-conveying member). In terms of the frontward-backward direction, it is disposed in the front portion (right portion in FIG. 1) of the casing 2. That is, the laser scanner unit 40 is disposed so that, in terms of the upward-downward direction in FIG. 1, it overlaps with the feeding-conveying roller 30.

The laser scanner unit 40 projects a beam 40a of laser light toward the peripheral surface of the photosensitive drum 41a (photosensitive member), which is an image bearing member disposed in the process cartridge 41 so that it can be rotated in the clockwise direction in FIG. 1, while modulating the beam 40a according to the data of the image to be formed, to expose the photosensitive member.

### <Processing Unit>

The process cartridge 41 which is a processing unit is structured as an image forming means which forms a developer image (toner image) on a sheet 7 of recording medium. The process cartridge 41 is provided with the photosensitive drum 41a which is a photosensitive member. The photosensitive drum 41a is rotatably disposed in the process cartridge 41 in such an attitude that its extends in the direction parallel to the front-rear direction of the sheet of paper on which FIG. 1 is drawn, that is, the direction which is intersectional to the vertical direction (upward-downward direction in FIG. 1). The photosensitive drum 41a is rotatable in the clockwise direction in FIG. 1. Further, the process cartridge 41 is provided with a charge roller 41c which is a charging means, a cleaning blade 41d which is a cleaning means, and a developer storing portion 41e which stores developer (toner). The process cartridge 41 is removably attached to the casing 2 of the main assembly of the image forming apparatus 1.

Referring to FIG. 1, the image forming apparatus 1 is structured so that when the process cartridge 41 is in its preset position (image forming position) in the casing 2, it roughly overlaps with the laser scanner unit 40 (exposing unit) in terms of the vertical direction (upward-downward direction n FIG. 1).

Further, in terms of the horizontal direction (left-right direction in FIG. 1), the process cartridge 41 is disposed on the downstream side of the laser scanner unit 40 (exposing unit) in terms of the direction in which a sheet 7 of recording medium is conveyed (leftward in FIG. 1). That is, the laser scanner unit 40 (exposing unit) is disposed in the rear portion of the main assembly of the image forming apparatus 1, being on the rear side (left side in FIG. 1) of the laser scanner unit 40 (exposing unit). In terms of the vertical direction (upward-downward direction), the process cartridge 41 is disposed in the top portion (top side in FIG. 1) of the main assembly of the image forming apparatus 1, being on the top side of the feeding-conveying cassette 31. In terms of the front-rear direction (left-right direction in FIG. 1) of the main assembly of the image forming apparatus 1, the process cartridge 41 is disposed so that it overlaps with the laser scanner unit 40.

### <Image Forming Operation>

The photosensitive drum 41a is rotationally driven in the counterclockwise direction of FIG. 1. As it is rotated, its peripheral surface is uniformly charged by the charge roller 41c. Then, the uniformly charged portion of the peripheral surface of the photosensitive drum 41a is exposed to the beam 40a of laser light emitted by the laser scanner unit 40 while being modulated according to the information of the image to be formed. Consequently, an electrostatic latent image is effected on the peripheral surface of the photosensitive drum 41a. Then, the electrostatic latent image formed on the peripheral surface of the photosensitive drum 41a is supplied with the toner from the developer storing portion 41e, by a development roller 41b, whereby the electrostatic latent image on the peripheral surface of the photosensitive drum 41a is developed into a visible image, that is, an image formed of toner (which hereafter will be referred to as “toner image”).

Meanwhile, each sheet 7 of recording medium fed into the main assembly of the image forming apparatus 1 by the feeding-conveying portion 3 is conveyed by the pair of conveyance rollers 60 (rotational conveying members), with which the conveying portion 6 is provided, while remaining pinched by the pair, to the pair of registration rollers 61 which are temporarily kept stationary. As the sheet 7 is conveyed to the pair of registration roller 61, the leading end of the sheet 7 runs into the nip between the pair of registration roller 61. Consequently, the sheet 7 is corrected in attitude by the coordination of the nip and the resiliency of the sheet 7, if the sheet 7 is askew. Thereafter, the pair of registration rollers 61 begin to be rotated with present timing. Thus, the sheet 7 is conveyed further by the pair of registration rollers 61, and put through a transfer nip N1 formed by the peripheral surface of the photosensitive drum 41a and the transfer roller 42, while remaining pinched by the pair of registration rollers 61. As the sheet 7 is conveyed through the transfer nip N1, transfer bias is applied to the transfer roller 42, whereby the toner image on the peripheral surface of the photosensitive drum 41a is transferred onto the sheet 7.

After the transfer of the toner image onto the sheet 7 of recording medium, the sheet 7 is conveyed through the fixation nip portion N2 formed by the heat roller 43a and pressure roller 43b, with which the fixing apparatus 43 is provided. As the sheet 7 is conveyed through the fixation nip portion N2, the sheet 7 and the toner image thereon are heated and pressed, whereby the toner image is thermally melted. Then, as the toner image cools down, it becomes fixed to the sheet 7. After the thermal fixation of the toner image to the sheet 7, the sheet 7 is conveyed further, and is discharged onto the delivery tray 51 by being conveyed by a pair of discharge rollers 50 while being pinched by the discharge rollers 50. The toner which was not transferred from the photosensitive drum 41a, being therefore remaining on the peripheral surface of the photosensitive drum 41a, is scraped away by a cleaning blade 41d.

### <Conveyance Guide>

The conveying portion 6 has a pair of conveyance rollers 60 which are rotational conveying member, and the pair of registration rollers 61. It has also a top guide 62 (conveyance guide) which extends from the front portion (right side in FIG. 1) of the main assembly of the image forming apparatus 1 to the adjacencies of the transfer nip portion N1. The mid portion of the top guide 62 is provided with the pair of conveyance rollers 60 and pair of registration roller 61. Further, the conveying portion 6 is provided with a bottom guide 63 (conveyance guide) which opposes the top guide 62. The bottom guide 63 extends from the adjacencies of the feeding-conveying roller 30 to the adjacencies of the pair of registration rollers 61. The mid portion of the bottom guide 63 is provided with the pair of conveyance rollers 60. Further, the conveying portion 6 is provided with a front guide 64 (conveyance guide), which is disposed in the front side (right side in FIG. 1). The front guide 64 has such a shape that enables the front guide 64 to oppose both the top and bottom guides 62 and 63, respectively; in cross-section, it appears like a bracket “<” (which looks like a Japanese letter “ku”).

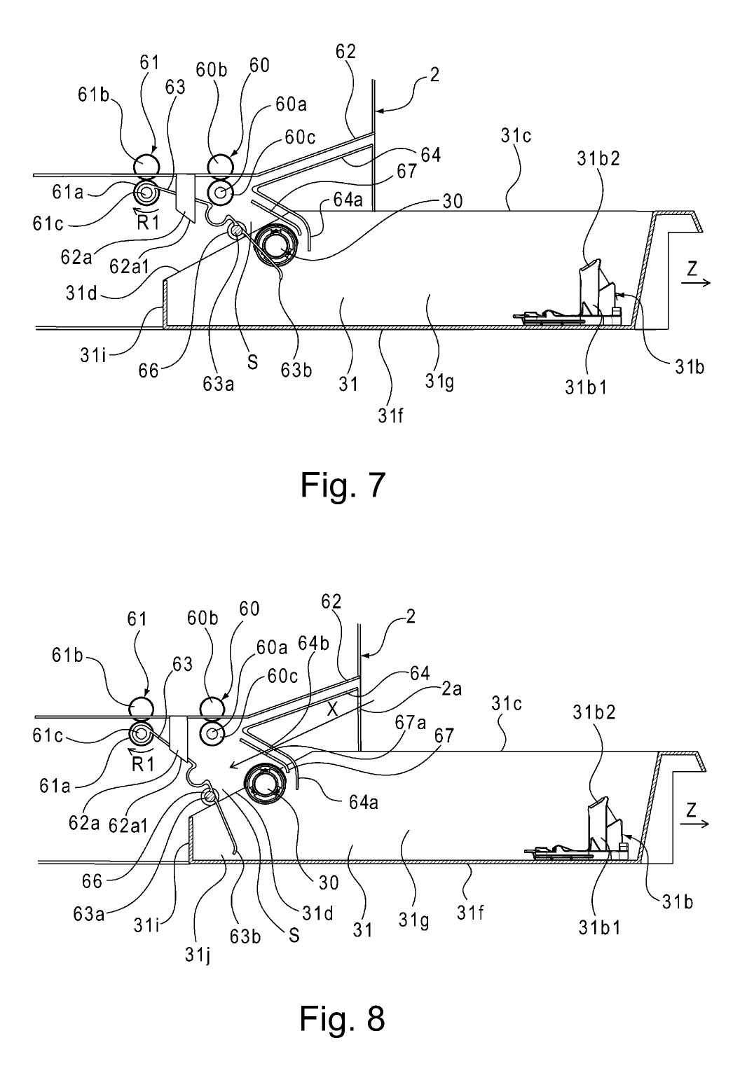

Further, the conveying portion 6 has a bottom guide 65a (conveyance guide), which is disposed so that it opposes the top guide 62. The bottom guide 65a extends from the adjacencies of the pair of registration rollers 61 to the adjacencies of the transfer nip portion N1. Moreover, the conveying portion 6 has the top and bottom guides 65b and 65c, respectively, which are disposed in a manner to oppose each other. The top guide 65b and bottom guide 65c extend from the adjacencies of the transfer nip portion N1 to the adjacencies of the fixation nip portion N2. Further, the conveying portion 6 has guides 65d and 65e, which are disposed in a manner to oppose each other. The guides 65d and 65e extend from the adjacencies of the fixation nip portion N2 to the adjacencies of the pair of discharge rollers 50. Next, referring to FIGS. 7 and 8, the conveying portion 6 has a bottom guide 67, which is supported by the casing 2 in a manner to oppose the top guide 64a of the front guide 64. The bottom guide 64 extends from the adjacencies of the feeding-conveying roller 30 to the adjacencies of the pair of conveyance rollers 60.

The casing 2 has a conveyance guide, which guides a sheet 7 of recording medium through the recording medium conveyance passage S, which extends from the feeding-conveying cassette 31 (cassette) to the process cartridge 41 (processing unit), by being contacted by the top or bottom surface of the sheet 7. These conveyance guides are made up of the bottom guide 63, front guide 64, top guide 62, bottom guide 65a, etc. Among these conveyance guides, the top guide 62 and bottom guide 63 are disposed between the laser scanner unit 40 (exposing unit) and feeding-conveying cassette 31 (cassette), in terms of the vertical direction (upward-downward direction in FIG. 1). The top guide 62 guides a sheet 7 of recording medium as the sheet 7 comes into contact with the top guide 62 by its top surface, whereas the bottom guide 63 guides the sheet 7 as the sheet 7 comes into contact with the bottom guide 63 by its bottom surface, while the sheet 7 is conveyed between the top and bottom guides 62 and 63.

Referring to FIG. 8, in this embodiment, if it is necessary for the feeding-conveying cassette 31 (cassette) in the casing 2 to be moved out of the casing, it is to be pulled by a user in the direction indicated by an arrow mark Z in FIG. 8. As the cassette 31 is pulled, the bottom guide 63 is made to rotate by its own weight in the direction indicated by an arrow mark R1 about the rotational shaft 61c of the registration roller 61a. Consequently, the bottom guide 63 rotates in such a manner that its front end portion moves into a storing portion 31j, which is in the adjacencies of the inward side of the rear plate 31i of the cassette 31.

As a sheet 7 of recording medium is fed into the main assembly of the image forming apparatus 1, the conveying portion 6 conveys the sheet 7 to the image forming portion 4. Then, it conveys the sheet 7 to the fixing apparatus 43 after the transfer of a toner image onto the sheet 7 by the image forming portion 4. Then, it conveys the sheet 7 to the discharging portion 5 after the thermal fixation of the toner image to the sheet 7 by the fixing apparatus 43. The conveyance guides, with which the conveying portion 6 is provided, guide the sheet 7 while the sheet 7 is conveyed through the main assembly of the image forming apparatus 1. In this embodiment, the recording medium conveyance passage S, through which the sheet 7 is conveyed from the feeding-conveying cassette 31 to the delivery tray 51, is shaped so that it looks like a letter “S” in cross-section in FIG. 1.

### <Moving Means>

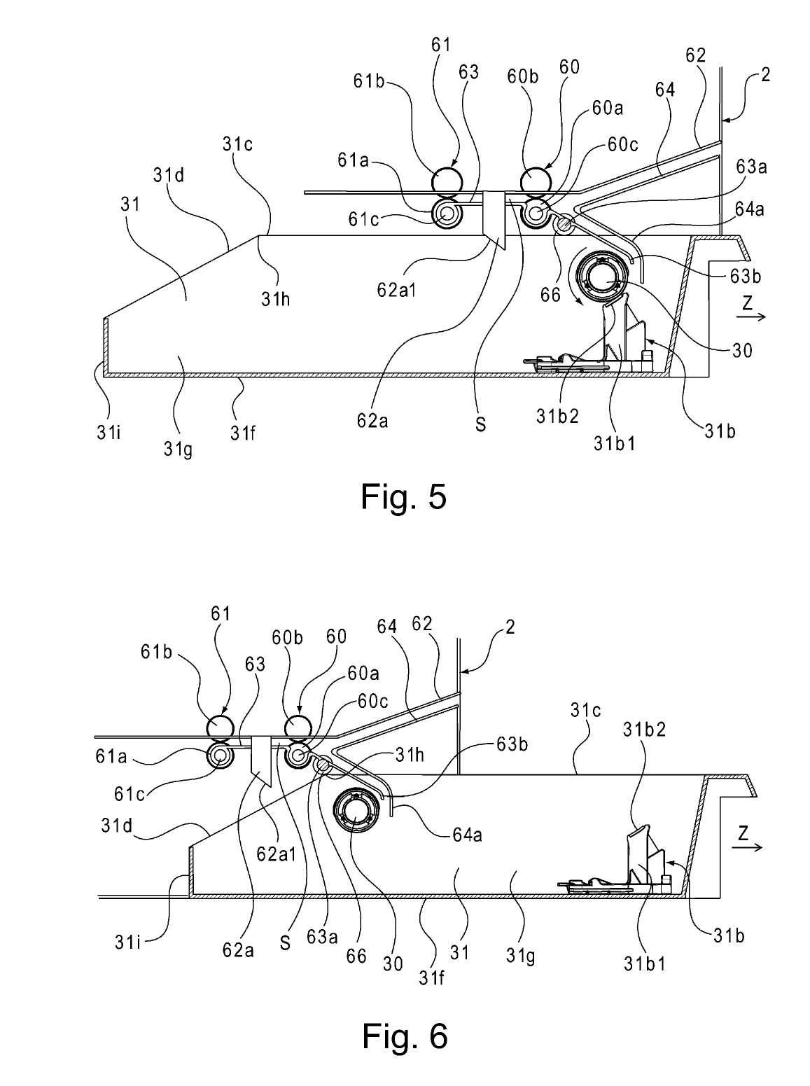

Referring to FIG. 5, the bottom guide 63 in this embodiment can be switched in position by a moving means between its normal position, shown in FIG. 5, in which it plays the role of a conveyance guide for guiding a sheet 7 of recording medium, and its retraction position, shown in FIG. 8, into which it is moved to make it easier for a user to remove a jammed sheet 7 of recording medium in the recording medium conveyance passage S.

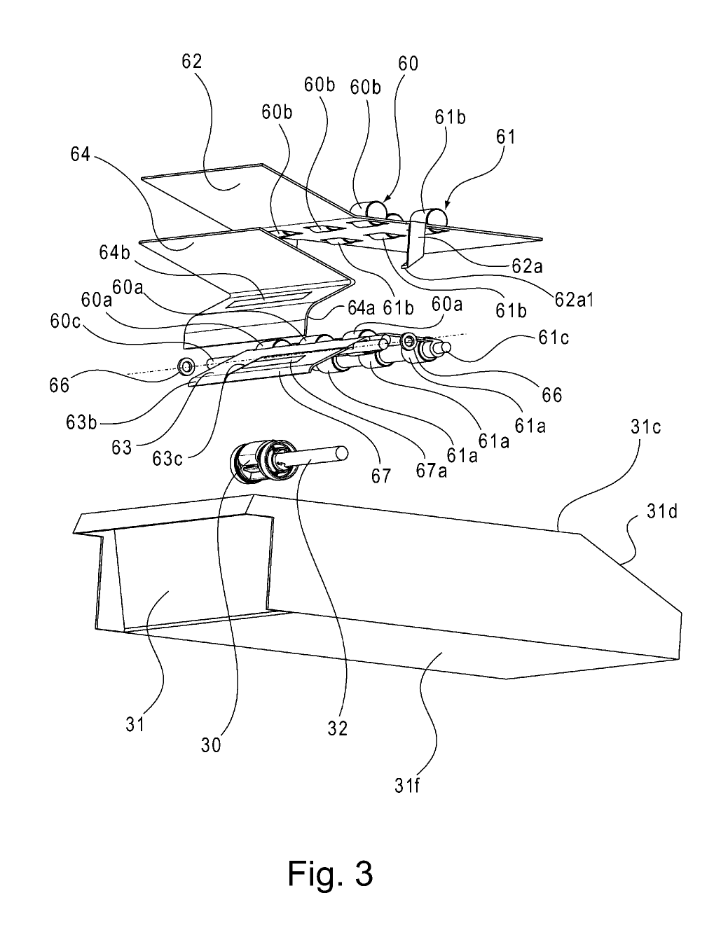

First, referring to FIGS. 2 and 3, the means for rotationally moving the bottom guide 63 is described about its structure. FIG. 2 is an exploded perspective view of a combination of the conveying portion 6 and feeding-conveying cassette 31 in this embodiment, as seen from the top side of the combination, when the feeding-conveying cassette 31 is in its preset position (sheet feeding position) in the casing 2. It is for showing the structure of the means for rotationally moving the bottom guide 63. FIG. 3 is an exploded perspective view of the combination of the conveying portion 6 and feeding-conveying cassette 31 in this embodiment, as seen from the bottom side of the combination, when the feeding-conveying cassette 31 is in its preset position (sheet feeding position) in the casing 2. It is for showing the structure of the means for rotationally moving the bottom guide 63.

Referring to FIGS. 2 and 3, the rotational shaft 32 of the feeding-conveying roller 30 is rotatably cantilevered to the casing 2. It is rotationally driven by an unshown motor as a driving force source. As it is driven, it rotates with its rotational shaft 32 about the rotational shaft 32 to feed a sheet 7 of recording medium into the main assembly of the image forming apparatus 1. More specifically, multiple sheets 7 of recording medium are loaded in layers on the mid plate 8 of the feeding-conveying cassette 31, which is under the upward pressure generated by the lift 31a. Thus, as the feed roller 30 is rotationally driven, it feeds the sheets 7 one by one into the conveying portion 6 while separating the sheets 7 in coordination with the separation pad 31b2.

Referring to FIG. 1, the feeding-conveying cassette 31 (cassette) holds multiple sheets 7 of recording medium. It is removably installable in the bottom portion of the casing 2. Referring to FIG. 2, the feeding-conveying cassette 31 has: the bottom plate 31f; and a pair of lateral plates 31g which are perpendicular to the bottom plate 31f. The upwardly facing surface of each lateral plate 31g has two sections, more specifically a horizontal section 31c (which hereafter will be referred to as horizontal guiding surface 31c) and a slant section (which hereafter will be referred to as slant guiding surface 31d) tilted by a preset angle relative to the horizontal guiding surface 31c). The horizontal guiding surface 31c and slant guiding surface 31d regulate the bottom guide 63 in attitude (angle). Further, the rear plate 31i of the feeding-conveying cassette 31 is provided with an opening as a conveyance guide escape 31e.

The front guide 64 which is a conveyance guide is supported by the casing 2. As multiple sheets 7 of recording medium are fed one by one rightward into the main assembly of the image forming apparatus 1 from the feeding-conveying cassette 31 while being separated by the coordination between the feeding-conveying roller 30 and separation pad 31b2, the front guide 64 causes each sheet 7 to U-turn leftward of FIG. 1, and guide the sheet 7 to the pair of conveyance rollers 60. The bottom guide 67 shown in FIGS. 7 and 8 is supported by the casing 2. It makes up a part of the conveyance guide which guides each sheet 7 from the feeding-conveying cassette 31 to the pair of conveyance rollers 60.

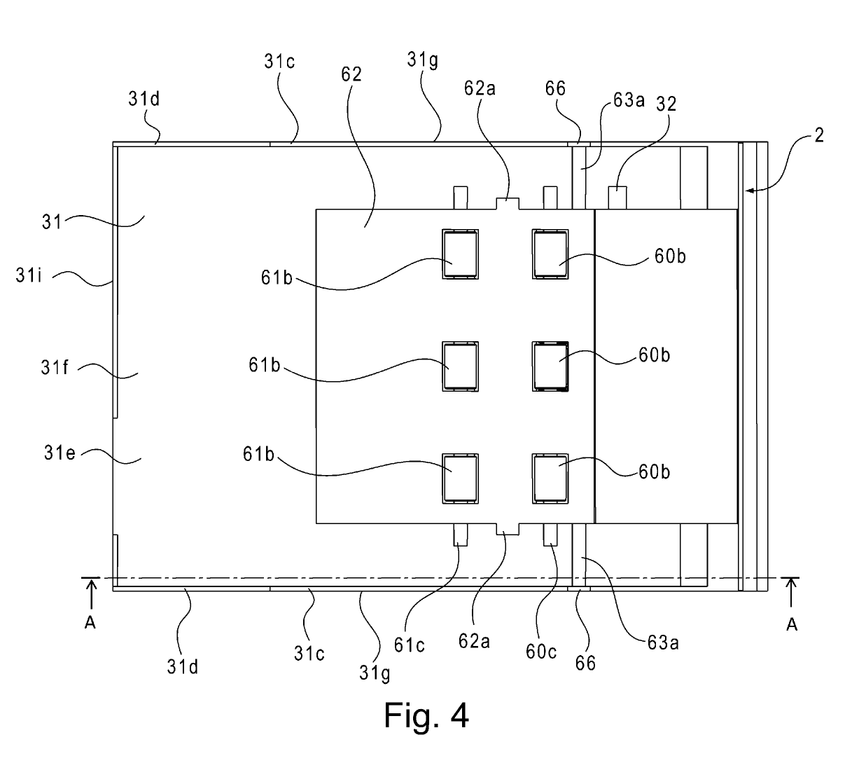

Each of the front guide 64 and bottom guide 67 is provided with slits 64b and 67a (openings), respectively, through which ambient light is allowed to enter the conveyance passage S in the direction indicated by an arrow mark X in FIG. 8. The top guide 62 is supported by the casing 2. It is provided with a pair of protrusive portions 62a which regulate the bottom guide 63 in attitude. The pair of protrusive portions 62a protrude downward from the lateral edges of the top guide 62, one for one, in terms of the direction parallel to the widthwise direction of the top guide 62 (upward-downward direction in FIG. 4, which is parallel to widthwise direction of sheet 7), in the direction which is perpendicular to the recording medium conveyance direction (left-right direction in FIG. 4).

The bottom guide 63 is made to rotationally (pivotally) move about the rotational shaft 61c of the registration roller 61a until it comes into contact with the engaging portion 62a1, which is the bottom portion of the protrusive portion 62a which protrudes downward from the edge of the top guide 62 in terms of the widthwise direction of the top guide 62, and which is J-shaped in cross section. Thus, the bottom guide 63 is held in such an attitude that its front end portion remains in the storing portion 31j in the adjacencies of the rear plate 31i in the feeding-conveying cassette 31.

Referring to FIG. 5, the top guide 62 guides a sheet 7 of recording medium to the pair of registration rollers 61 while the sheet 7 is conveyed by the pair of conveyance rollers 60, remaining pinched by the rollers 60. Referring to FIGS. 5-8, the bottom guide 63 is supported by its downstream end (left end in FIG. 5), in terms of the recording medium conveyance direction, so that it is allowed to pivot about the rotational shaft 601c of the registration roller 61a. The mid portion of the bottom guide 63, in terms of the recording medium conveyance direction (left-right direction in FIG. 5), is provided with a bottom guide supporting shaft 63a. Referring to FIG. 4, the lengthwise end portions of this supporting shaft 63a are fitted with a pair of rotational regulation rollers 66, one for one.

Referring to FIGS. 5-8, the image forming apparatus 1 is structured so that the pair of regulation rollers 66 rotate on the horizontal guiding surface 31c and slant guiding surface 31d, which make up the upwardly facing surface of each of the lateral plates 31g of the feeding-conveying cassette 31. Thus, as a user draws outward the feeding-conveying cassette 31 in the main assembly of the image forming apparatus 1 in the direction indicated by an arrow mark Z in FIGS. 5-8 as shown in FIG. 5, the regulation rollers 66 rotate on the corresponding horizontal guiding surfaces 31c as the horizontal guiding surfaces 31c move in the direction indicated by the arrow mark Z in FIG. 5. As the border line between the horizontal guiding surface 31c and slant guiding surface 31d, shown in FIG. 6, moves past the regulation roller 66, the regulation roller 66 begin to rotate on the slant guiding surface 31d as the slant guiding surface 31d moves in the direction indicated by the arrow mark Z in FIGS. 7 and 8.

Consequently, the bottom guide 63 pivotally moves in the direction indicated by the arrow mark R1 in FIGS. 7 and 8 about the rotational shaft 61c of the registration roller 61a in a manner to retract away from the top guide 62. That is, as the feeding-conveying cassette 31 in the casing 2 is drawn outward of the casing 2 by a user, the bottom guide 63 retracts from the top guide 62 in such a manner that its rear portion (upstream end portion, in terms of the recording medium conveyance direction) moves into the storing portion 31j which is the adjacencies of the rear plate 31i, in the feeding-conveying cassette 31. In other words, the front guide 64 pivotally moves in a manner of separating from the top guide 62. On the other hand, the bottom guide 67 is immovably attached to the casing 2. Therefore, it remains opposing the top guide 64a of the front guide 64.

That is, in this embodiment, as the feeding-conveying cassette 31 (cassette) in its preset position (recording medium feeding position) in casing 2 is moved outward of the casing 2 in the direction indicated by the arrow mark Z in FIGS. 5-8, the bottom guide 63 is pivotally moved by the bottom guide moving means so that its front end portion (upstream portion in terms of recording medium conveyance direction) moves into the storing portion 31i, which is the inward adjacencies of the rear plate 31i of the feeding-conveying cassette 31.

This bottom guide moving means has the pair of regulation rollers 66 which function as regulating members. Referring to FIG. 5, the image forming apparatus 1 is structured so that each regulation roller 66 is allowed to rotate on the corresponding horizontal guiding surface 31c, shown in FIG. 5, and slant guiding surface 31d, shown in FIGS. 7 and 8, between the front end of horizontal guiding surface 31c (regulatory position) and the rear end of the slant guiding surface 31d (nonregulatory position). The horizontal guiding surface 31c shown in FIG. 5 (regulatory surface) prevents the bottom guide 63 from pivotally moving (changing in attitude), whereas the slant guiding surface 31d (nonregulatory surface) shown in FIGS. 7 and 8 allows the bottom guide 63 to pivotally move (change in attitude).

The pair of regulation rollers 66 are rotatably supported by a pair of supporting shafts 63a, one for one, attached to the edge portions of the bottom guide 63 in terms of the widthwise direction of the bottom guide 63. Thus, as the bottom guide 63 pivotally moves in the direction indicated by the arrow mark R1 in FIGS. 7 and 8 about the rotational shaft 61c of the registration roller 61a, the pair of regulation rollers 66 move with the bottom guide 63.

As the feeding-conveying cassette 31 (cassette) in the casing 2 is drawn by a user in the direction indicated by the arrow mark Z in FIGS. 5-8, each of the pair of regulation rollers 66 rotates on the horizontal guiding surface 31c of the corresponding lateral plate 31g of the feeding-conveying cassette 31, and then, on the slant guiding surface 31d of the corresponding lateral plate 31g; it moves relative to the horizontal guiding surface 31c and slant guiding surface 31d.

On the other hand, as the feeding-conveying cassette 31 (cassette) is inserted into the casing 2 in the opposite direction from the direction indicated by the arrow mark Z in FIGS. 5-8, each of the pair of regulation rollers 66 rotates on the slant guiding surface 31d of the corresponding lateral plate 31g, which is a part of the upwardly facing surface of the lateral plate 31g, and then, on the horizontal guiding surface 31c of the corresponding lateral plate 31g, which is the other part of the upwardly facing surface of the lateral plate 31g; it moves relative to the upwardly facing surface of the lateral plate 31g.

As each of the pair of regulation rollers 66 rotates on the horizontal guiding surface 31c or slant guiding surface 31d, the bottom guide 63 remains pressed upon the horizontal guiding surface 31c or slant guiding surface 31d, respectively, by its own weight.

Referring to FIG. 8, as the feeding-conveying cassette 31 (cassette) in the casing 2 is drawn by a user in the direction indicated by the arrow mark Z in FIG. 8, each regulation roller 66 (regulatory member) moves into its retraction position (nonregulatory position) on the slant guiding surface 31d. That is, the bottom guide 63 pivotally moves in such a manner that its rear portion moves into the storing portion 31j in the inward adjacencies of the rear plate 31i of the feeding-conveying cassette 31.

As the rear portion of the bottom guide 63 moves into the storing portion 31j in the inward adjacencies of the rear plate 31i, the bottom guide 63 is caught by its bottom surface by the engaging portion 62a1, that is, the bottom end portion, of each of the pair of protrusive portions 62a which protrude downward from the lateral edges of the top guide 62, and which is shaped like a letter “J” in cross-section. Thus, the bottom guide 63 is held in its retraction position, shown in FIG. 8, by its own weight.

On the other hand, as the feeding-conveying cassette 31 is inserted into the main assembly of the image forming apparatus 1 in the opposite direction from the direction indicated by the arrow mark Z in FIG. 8, each of the pair of regulation rollers 66 rotates in contact with the slant guiding surface 31d as if it rolls on the slant guiding surface 31d, causing thereby the bottom guide 63 to pivotally move in the opposite direction from the direction indicated by the arrow mark R1 in FIGS. 7 and 8, about the rotational shaft 61c of the registration roller 61a. Then, as the border line 31h, shown in FIG. 6, moves past the regulation roller 66, the regulation roller 66 rotates in contact with the horizontal guiding surface 31c as if it rolls on the horizontal guiding surface 31c. Thus, the bottom guide 63 is held in its regulatory position (normal position) shown in FIG. 5. By the way, regarding the choice of the regulating members with which the bottom guide 63 is provided, various members can be employed as long as they allow the horizontal guiding surface 31c and slant guiding surface 31d to slide in contact with them.

The feeding-conveying cassette 31 stores multiple sheets 7 of recording medium so that the sheets 7 are loaded in layers on the mid plate 8 in the cassette 31. The sheets 7 are fed rightward one by one into the main assembly of the image forming apparatus 1 while being separated by the coordination between the feeding-conveying roller 30, which rotates in the counterclockwise direction of FIG. 1, and the separation pad 31b2. As each sheet 7 is fed into the main assembly, it is guided by the top guide 64a of the front guide 64, so that it U-turns to be conveyed leftward in FIG. 1. Meanwhile, the sheet 7 is supported by its bottom surface, by the bottom guide 63 held in its regulatory position shown in FIG. 5, in such a manner that it is allowed to slide on the bottom guide 63. Thus, the sheet 7 is conveyed past the pair of conveyance rollers 60, and then, to the pair of registration rollers 61.

The bottom guide 63 has a bent portion 63b which changes each sheet 7 of recording medium in conveyance direction so that the sheet 7 begins to be conveyed in the opposite direction from the direction in which the sheet 7 is fed into the main assembly, as the sheets 7 are fed one by one into the main assembly of the image forming apparatus 1 by the coordination of the feeding-conveying roller 30 and separation pad 31b2, from the feeding-conveying cassette 31 (cassette).

The bottom guide 63 pivotally moves about the rotational shaft 61a of the registration roller 61a, shown in FIGS. 6 and 7, between its retraction position, shown in FIG. 5, and its normal position (non-retraction position) shown in FIG. 8. Thus, in order to prevent the bottom guide 63 from colliding with the feeding-conveying roller 30 and the rotational shaft 32 of the feeding-conveying roller 30 during the pivotal movement of the bottom guide 63, the bottom guide 63 is provided with a recess 63c shown in FIG. 3.

### <Action of Bottom Guide Moving Means>

Next, referring to FIGS. 4-8, the action of the means for moving the bottom guide 63 is described. FIG. 4 is a top view of a combination of the conveying portion 6 and feeding-conveying cassette 31 when the bottom guide 63 is in its normal position (sheet guiding position) shown in FIG. 5. It is for describing the structure of the means for moving the bottom guide 63. FIG. 5 is a sectional view of the combination at a plane A-A in FIG. 4. Referring to FIG. 5, when the feeding-conveying cassette 31 is in its preset position (sheet feeding position) in the main assembly of the image forming apparatus 1, the bottom guide 63 is held in normal position (sheet guiding position), and each of the pair of regulation rollers 66 rotatably supported by the corresponding lengthwise end portion of the supporting shaft 63a with which the bottom guide 63 is provided, is in contact with the horizontal guiding surface 31c, that is, a part of the upwardly facing surface, of the corresponding lateral plate 31g, being therefore held in its normal position (sheet guiding position) shown in FIG. 5.

FIG. 6 is a sectional view of a combination of the conveying portion 6 and feeding-conveying cassette 31 at the plane A-A in FIG. 4. It is for showing the structure of the means for moving the bottom guide 63 when the feeding-conveying cassette 31 in the casing 2 of the main assembly of the image forming apparatus 1 begins to be drawn outward in the direction indicated by the arrow mark Z in FIG. 6, and therefore, the bottom guide 63 begins to pivotally move from the normal position (sheet guiding position) shown in FIG. 5 to its retraction position shown in FIG. 8.

Referring to FIG. 6, as the feeding-conveying cassette 31 in the casing 2 of the main assembly of the image forming apparatus 1 is drawn by a preset amount by a user in the direction indicated by the arrow mark Z in FIG. 6, the border line 31h between the horizontal guiding surface 31c and slant guiding surface 31d reaches the corresponding regulation roller 66, which was rotating in contact with the horizontal guiding surface 31c, that is, a part of the upwardly facing surface, of the corresponding lateral plate 31g with which the feeding-conveying cassette 31 is provided.

FIG. 7 is a sectional view of the combination of the conveying portion 6 and feeding-conveying cassette 31 at the plane A-A in FIG. 4 after the feeding-conveying cassette 31 which was in the state shown in FIG. 6 was drawn further outward relative to the casing 2 of the main assembly of the image forming apparatus 1 in the direction indicated by the arrow mark Z in FIG. 7. It is for showing the structure of the means for moving the bottom guide 63. As the feeding-conveying cassette 31 is drawn outward relative to the casing 2 of the main assembly of the image forming apparatus 1 in the direction indicated by the arrow mark Z in FIG. 7, the slant guiding surface 31d, which is a part of the upwardly facing surface of one of the pair of lateral plates 31g with which the feeding-conveying cassette 31 is provided comes into contact with the corresponding regulation roller 66.

Thus, the bottom guide 63 is made by its own weight to pivotally move in the direction indicated by the arrow mark R1 in FIG. 7 about the rotational shaft 61c of the registration roller 61a. Since the bottom guide 63 is provided with the escape 63c, shown in FIG. 3, it does not occur that, as the bottom guide 63 pivotally moves in the abovementioned direction, it collides with the feeding-conveying roller 30 and the rotational shaft 32 of the feeding-conveying roller 30.

FIG. 8 is a sectional view of the combination of the conveying portion 6 and feeding-conveying cassette 31 at the plane A-A in FIG. 4 after the feeding-conveying cassette 31 was drawn relative to the casing 2 of the main assembly of the image forming apparatus 1 in the direction indicated by the arrow mark Z in FIG. 8 far enough for the bottom guide 63, which was in the state shown in FIG. 7, to pivotally move into its retraction position. It is for showing the structure of the means for moving the bottom guide 63. Referring to FIG. 8, as the feeding-conveying cassette 31 in the casing 2 of the main assembly of the image forming apparatus 1 is drawn by a user in the direction indicated by the arrow mark Z in FIG. 8 relative to the casing 2, the bottom guide 63 is made by its own weight to pivotally move in the direction indicated by the arrow mark R1 in FIG. 8 about the rotational shaft 61c of the registration roller 61a.

As the bottom guide 63 pivotally moves as described above, it comes into contact with the bottom guide engaging portions 62a1, which is the bottom portion of each of the pair of protrusive portions 62a which protrude downward from the lateral edges of the top guide 62, and which is shaped like a letter “J” in cross-section. The contact completes the pivotal moving of the bottom guide 63 into the retraction position shown in FIG. 8. Thereafter, the feeding-conveying cassette 31 can be drawn out of the main assembly of the image forming apparatus 1 without colliding with the bottom guide 63, which is in its retraction position shown in FIG. 8, because the rear plate 31i of the feeding-conveying cassette 31 is provided with the escape 31e (recess, opening).

In this embodiment, as the feeding-conveying cassette 31 in the main assembly of the image forming apparatus 1 is drawn outward by a user, the bottom guide 63 pivotally moves into the its retract position shown in FIG. 8. That is, the bottom guide which includes the bend portion 63b, which is a part of the sheet conveyance passage S, retracts in a manner to expose the recording medium conveyance passage S.

As the feeding-conveying cassette 31 in the casing 2 of the main assembly of the image forming apparatus 1 is drawn outward of the casing 2 by a user, the bottom guide 63 provided with the bend portion 63b which is a part of the recording medium conveyance passage S, through which a sheet 7 fed into the main assembly is conveyed, moves into the storing portion 31j which is in the inward adjacencies of the rear plate 31i of the feeding-conveying cassette 31, making it easier for the user to access the recording medium conveyance passage S from the underside of the passage S, in order to remove a sheet 7 of recording medium jammed at the bend portion 63b of the passage S, at which the sheet 7 fed from the feeding-conveying cassette 31 into the main assembly is made to U-turn to be conveyed leftward in FIG. 1.

In this embodiment, the casing 2 is provided with the slit 2a (opening). Further, the top guide 64a of the front guide 64, and the bottom guide 67 are provided with slits 64b and 67a, respectively. Further, the image forming apparatus 1 is structured so that the slits 2a, 64b, and 67a align in the direction indicated by an arrow mark X in FIG. 8.

Therefore, the ambient light in the adjacencies of the main assembly of the image forming apparatus 1 is allowed to enter the conveyance passage S in the direction indicated by the arrow mark X in FIG. 8. Thus, when a user has to remove a jammed sheet 7 of recording medium in the conveyance passage S, the interior of the conveyance passage S is light, making it easier for the user to see the inside of the conveyance passage S, through which the sheet 7 is conveyed, and therefore, easier for the user to remove the jammed sheet 7 in the conveyance passage S.

### Embodiment 2

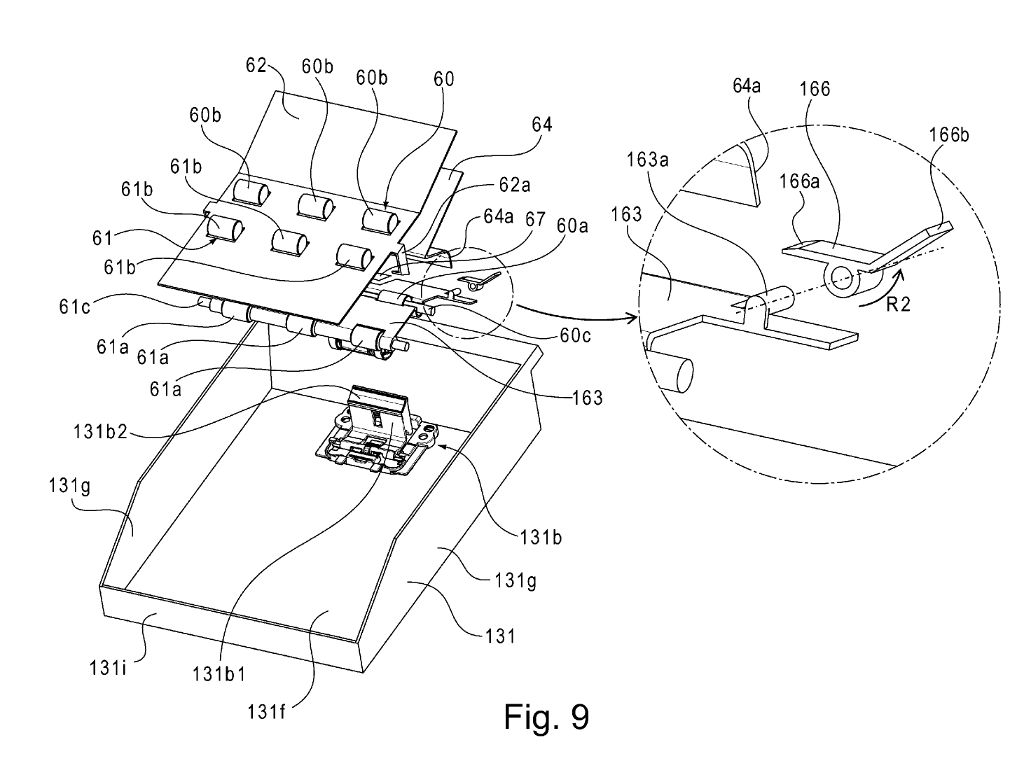

Next, referring to FIGS. 9-14, the image forming apparatus in the second embodiment of the present invention is described about its structure. By the way, the members of the image forming apparatus in this embodiment, and the portions thereof, which are similar in structure as the counterparts in the first embodiment, are given the same referential codes as the counterparts, and are not described. Further, even if a given member of the image forming apparatus in this embodiment is different in referential code from the counterpart in the first embodiment, it is not described as long as it is the similar in name to the counterpart.

### <Means for Rotationally Moving Bottom Guide>

First, referring to FIG. 9, the means for rotationally moving the bottom guide 163 in this embodiment is described about its structure. FIG. 9 is an exploded perspective view of a combination of the conveying portion 6 and feeding-conveying cassette 131 in this embodiment, as seen from the top side of the combination. It is for showing the structure of the means for rotationally moving the bottom guide 163. Referring to FIG. 9, the bottom guide 163, which is one of the conveyance guides in this embodiment is provided with a supporting shaft 163a which rotatably supports a regulating plate 166 which is a regulating member. The regulating plate 166 is always under the pressure generated in the direction indicated by an arrow mark R2 in FIG. 9 by an unshown spring which function as pressure generating means. In this embodiment, it is the regulating plate 166 that controls the operation for switching the bottom guide 163 in position.

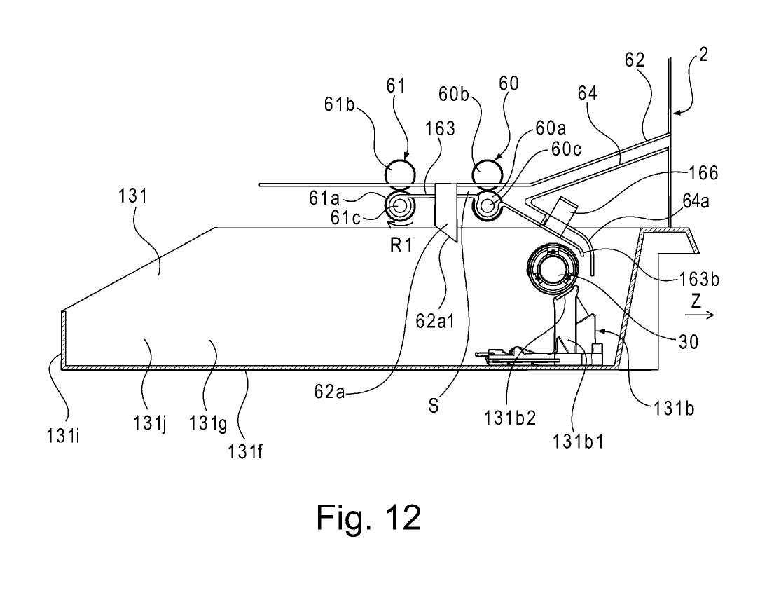

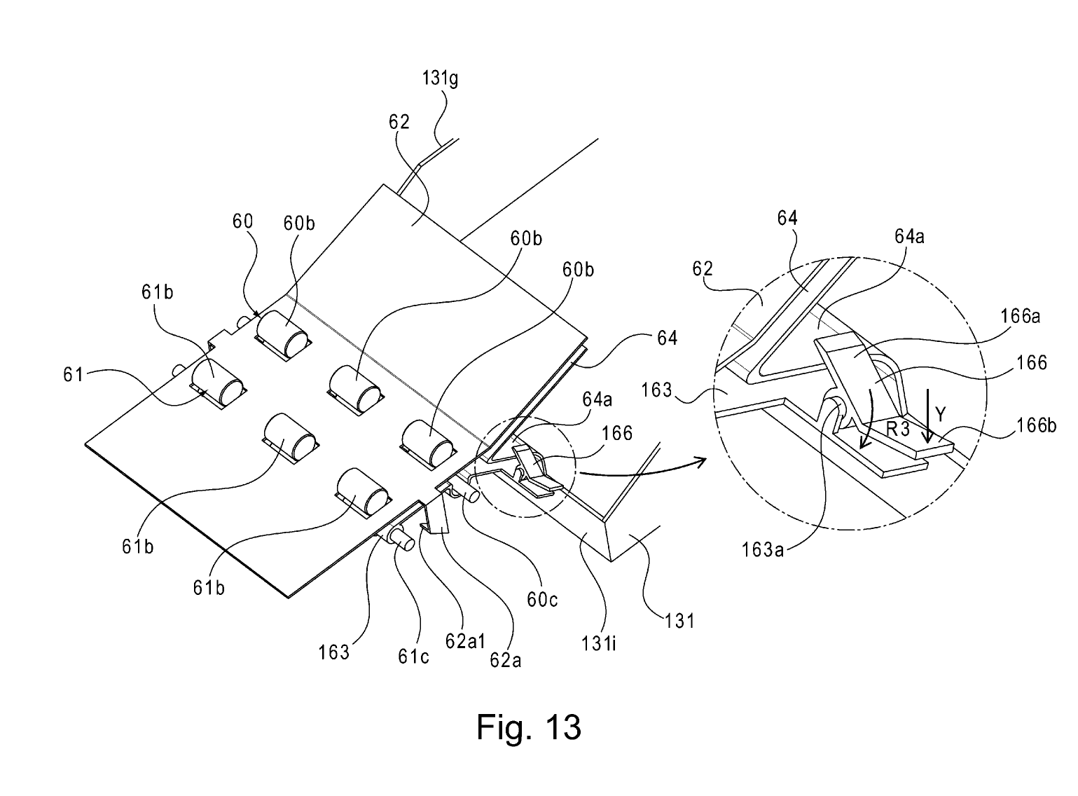

In this embodiment, first, a user is to draw the feeding-conveying cassette 131 in the casing 2 in the direction indicated by an arrow mark Z in FIG. 12 by a certain distance, and then, to press the tab portion 166b of the regulating plate 166 in the direction indicated by an arrow mark Y in FIG. 13 against the resiliency of the aforementioned spring. As the tab portion 166b is pressed, the regulating plate 166 pivotally moves in the direction indicated by an arrow mark R3 in FIG. 13 about the supporting shaft 163a. Consequently, the engaging portion 166a of the regulating plate 166 retracts from the top guide 64a of the front guide 64, allowing thereby the bottom guide 63 to be made by its own weight to pivotally move in the direction indicated by an arrow mark R2 in FIG. 12 about the rotational shaft 61c of the registration roller 61. As a result, the bottom guide 63 changes in attitude in such a manner that its bottom portion moves into the storing portion 131j which is in the inward adjacencies of the rear plate 131i of the feeding-conveying cassette 131.

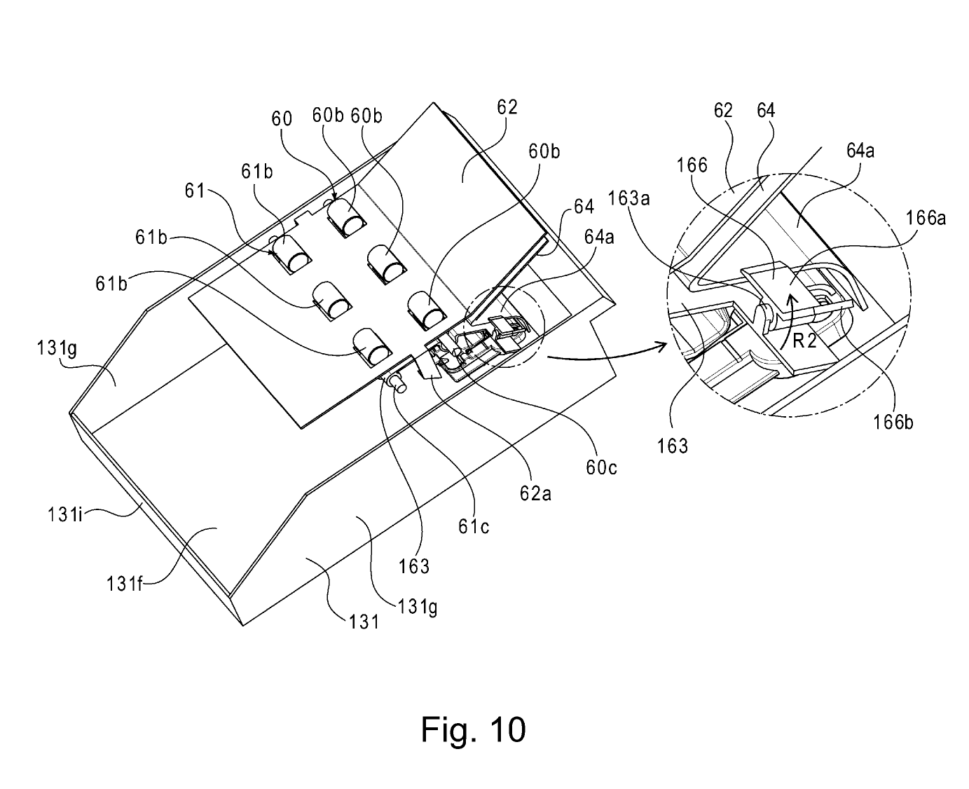

In this embodiment, the means for rotationally moving the bottom guide 163 has the regulating plate 166, as a regulating member, which can be changed in attitude between the regulatory one, shown in FIG. 10, in which it prevents the bottom guide 163 from rotationally moving, and the nonregulatory one, shown in FIG. 13, in which it allows the bottom guide 163 to pivotally move. When the regulating plate 166 is in the regulatory position shown in FIG. 10, it always remains pressed in the direction indicated by an arrow mark R2 in FIG. 9 by the unshown spring. Thus, the engaging portion 166a of the regulating plate 166 remains in contact with the top guide 64a of the front guide 64. Therefore, the bottom guide 163 is kept stationary against its own weight.

As a user presses the tab portion 166b of the regulating plate 166 in the direction indicated by an arrow mark Y in FIG. 13 against the resiliency of the unshown spring, the regulating plate 166 pivotally moves into the release position shown in FIG. 13. Thus, its engaging portion 166a retracts away from the top guide 64a of the front guide 64; it disengages from the bottom guide 163. Consequently, the bottom guide 63 is made by its own weight to pivotally move in the direction indicated by the arrow mark R1 in FIG. 12 about the rotational shaft 61c of the registration roller 61a.

The user is to draw the feeding-conveying cassette 131 (cassette) in the casing 2 in the direction indicated by an arrow mark Z in FIG. 12. In order for the user to draw the feeding-conveying cassette 131, the user is to pivotally move the regulating plate 166 (preventing member) into the release position shown in FIG. 13, so that the bottom guide 163 is allowed to be made by its own weight to pivotally move in the direction indicated by an arrow mark R1 in FIG. 12 about the rotational shaft 61c of the registration roller 61a, in such a manner that the front end portion of the bottom guide 163 moves into the storing portion 131j which is in the inward adjacencies of the rear plate 131i of the feeding-conveying cassette 131 (cassette).

The bottom guide 163 (conveyance guide) has a bent portion 163b which roughly reverses a sheet 7 of recording medium in conveyance direction, in coordination with the top guide 64a of the front guide 64, as soon as the sheet 7 is fed into the main assembly of the image forming apparatus 1 from the feeding-conveying cassette 131. Further, the casing 2 and the top and bottom guides 64a and 67 of the front guide 64, which make up the conveyance guide in this embodiment, are provided with slits 2a, 64b and 67a, respectively, like the counterparts in the first embodiment described previously with reference to FIG. 8. Thus, ambient light is allowed to enter the main assembly of the image forming apparatus 1 in the direction indicated by the arrow mark X in FIG. 8, through the slits 2a, 64b, and 67a, making it easier for a user to see the inside of the conveyance passage S (conveyance passage interior) through which the sheet 7 is conveyed.

### <Action of Means for Rotationally Moving Bottom Guide>

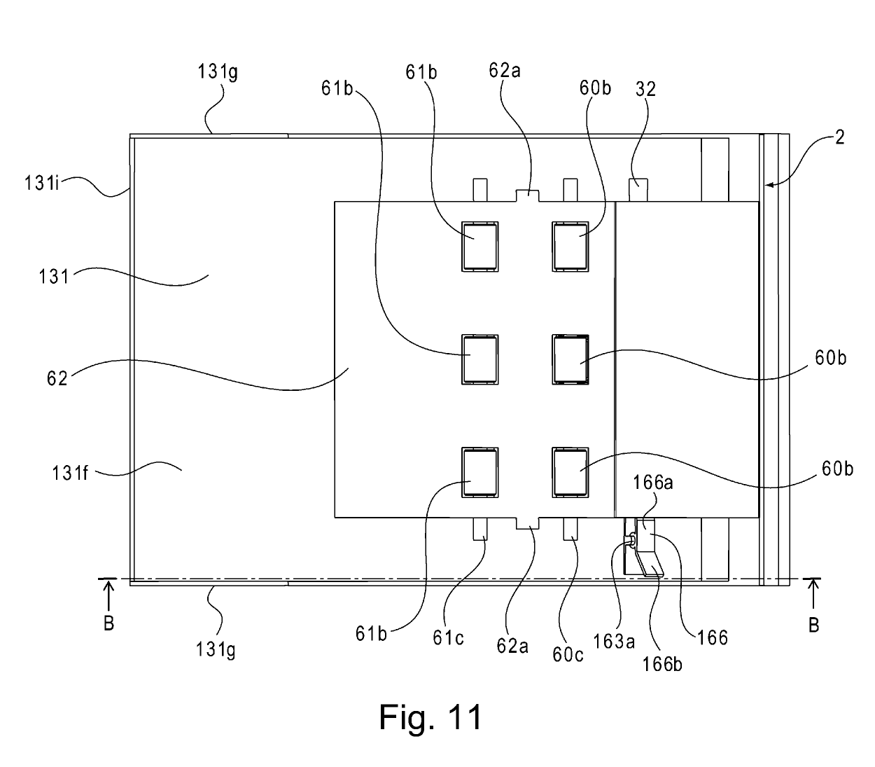

Next, referring to FIGS. 10-14, the means, in this embodiment, for causing the bottom guide 163 to rotationally move is described about its action. FIG. 10 is an exploded perspective view of a combination of the conveying portion 6 and feeding-conveying cassette 131 in this embodiment, as seen from the top side of the combination, when the bottom guide 163 is in its normal position. It is for showing the structure of the means for causing the bottom guide 163 to pivotally move. FIG. 11 is a top view of the combination of the conveying portion 6 and feeding-conveying cassette 131 when the bottom guide 163, shown in FIG. 10, is in its retraction position. It is for showing the structure of the means. FIG. 12 is a sectional view of the combination, at a plane B-B in FIG. 11, when the bottom guide 163 is in the normal position. It is for showing the means for causing the bottom guide 163 to pivotally move.

Referring to FIG. 10, the regulating plate 166 is kept pressed in the direction indicated by an arrow mark R2 in FIG. 10 by an unshown spring. Thus, an engaging portion 166a of the regulating plate 166, which is one of the lengthwise end portion of the regulating plate 166, remains in contact with the top surface of the top guide 64a of the front guide 64, in such a manner that it presses on the front guide 64. Thus, the bottom guide 163, which is supported by the rotational shaft 61c of the registration roller 61a so that it is allowed to pivotally move about the rotational shaft 61c, is prevented from being made by its own weight to pivotally move in the direction indicated by the arrow mark R1 in FIG. 12. Therefore, the bottom guide 163 is held in its normal position show in FIG. 12.

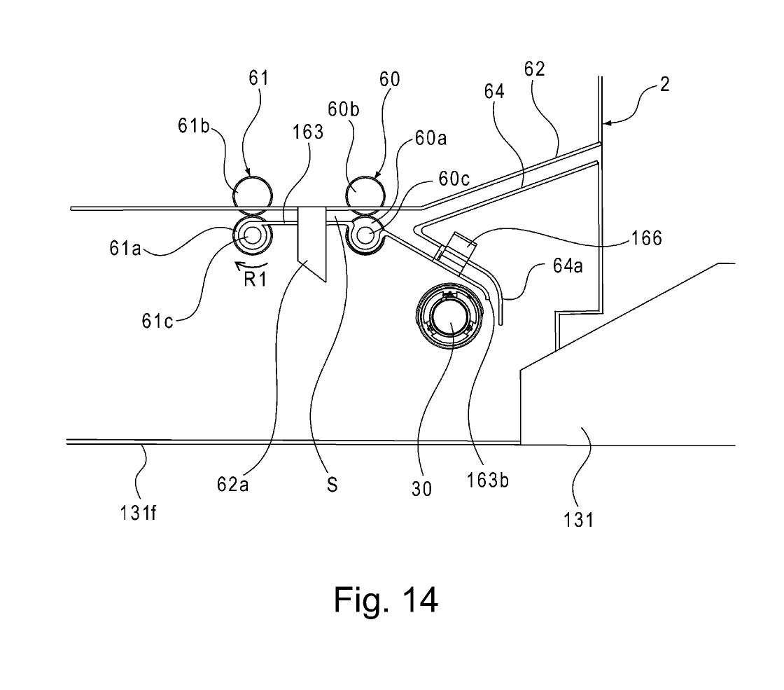

FIG. 13 is a perspective view of a combination of the conveying portion 6 and regulating plate 166, as seen from the top side of the combination, when the bottom guide 163 is ready to pivotally move from its normal position, shown in FIG. 12, to its retraction position, like the bottom guide 63 in the first embodiment described above with reference to FIG. 8. It is for describing the structure of the means for causing the bottom guide 163 to pivotally move. FIG. 14 is a sectional view of the combination at a plane B-B in FIG. 11 when the bottom guide 163 shown in FIG. 13 has just been enabled to pivotally move from its normal position to its retraction position. It is for showing the structure of the means.

Referring to FIG. 13, if it is necessary for a user to remove a sheet 7 of recording medium jammed in the conveyance passage S, the user is to draw the feeding-conveying cassette 131 in the main assembly of the image forming apparatus 1 in the direction indicated by the arrow mark Z in FIG. 12. First, the user is to press the tab portion 166b of the regulating plate 166 in the direction indicated by the arrow mark Y in FIG. 13 against the resiliency of the unshown spring. As the tab portion 166b is pressed, the regulating plate 166 pivotally moves in the direction indicated by the arrow mark R3 in FIG. 13 about the supporting shaft 163a. Thus, the bottom guide 163 is freed from the engaging portion 166a of the regulating plate 166. As a result, the bottom guide 163 is made by its own weight to pivotally move in the direction indicated by an arrow mark R4 about the rotational shaft 61c of the registration roller 61a shown in FIG. 14, to retract into its retraction position like the bottom guide 63 in the first embodiment described above with reference to FIG. 8.

Then, the bottom guide 163 is caught by the engaging portion 62a1, which is the front portion of each of the pair of protrusive portions which protrude downward from the edges of the top guide 62, one for one, in terms of the widthwise direction of the top guide 62, and which is J-shaped in cross section. This ends the pivotal movement of the bottom guide 163 into its retraction position.

Also in this embodiment, a user is to draw the feeding-conveying cassette 131 in the casing 2 of the main assembly of the image forming apparatus 1 in the direction indicated by the arrow mark Z in FIG. 12. Then, the user is to press the tab portion 166b of the regulating plate 166 to free the bottom guide 163 from the engaging portion 166a. As the tab portion 16b is pressed, the bottom guide 163 is made by its own weight to pivotally move into its retraction position like the bottom guide 63 in the first embodiment described above with reference to FIG. 8. That is, the bottom guide 163 which includes the bent portion 163b (which corresponds to bend portion of the conveyance passage S shown in FIG. 14), retracts in a manner to expose the conveyance passage S.

Next, a user is to draw the feeding-conveying cassette 131 in the casing 2 of the main assembly of the image forming apparatus 1 in the direction indicated by the arrow Z in FIG. 8. Since the image forming apparatus 1 is structured so that as the feeding-conveying cassette 131 in the main assembly is drawn in the above-described direction, the front portion of the bottom guide 163 having the bent portion 163b which is a part of the conveyance passage S through which a sheet 7 of recording medium is conveyed after being fed into the main assembly, moves into the storing portion 131j which is in the inward adjacencies of the rear plate 131i, making it easier for a user to access the conveyance passage S from the under side of the conveyance passage S. That is, this embodiment makes it easier for a user to remove a sheet 7 of recording medium having jammed in the portion of the conveyance passage S, which corresponds in position to where the sheet 7 is U-turned leftward in FIG. 1 after being fed rightward of FIG. 1 into the main assembly from the feeding-conveying cassette 131.

By the way, the separating portion 131b, separation pad holder 131b1, separation pad 131b2, bottom plate 131g, and rear plate 131i, which are shown in FIGS. 9-14 correspond to separating portion 31b, separation pad holder 31b1, separation pad 31b2, bottom plate 31f, lateral plates 31g, and rear plate 31b in the first embodiment described above. Each of these members is the same in structure and effect as the counterparts in the first embodiment, and therefore, is not described here in order not to repeat the same descriptions. Other structural components in this embodiment are also similar in structure to the counterparts in the first embodiment, and can offer the similar effects as the counter parts.

### Embodiment 3

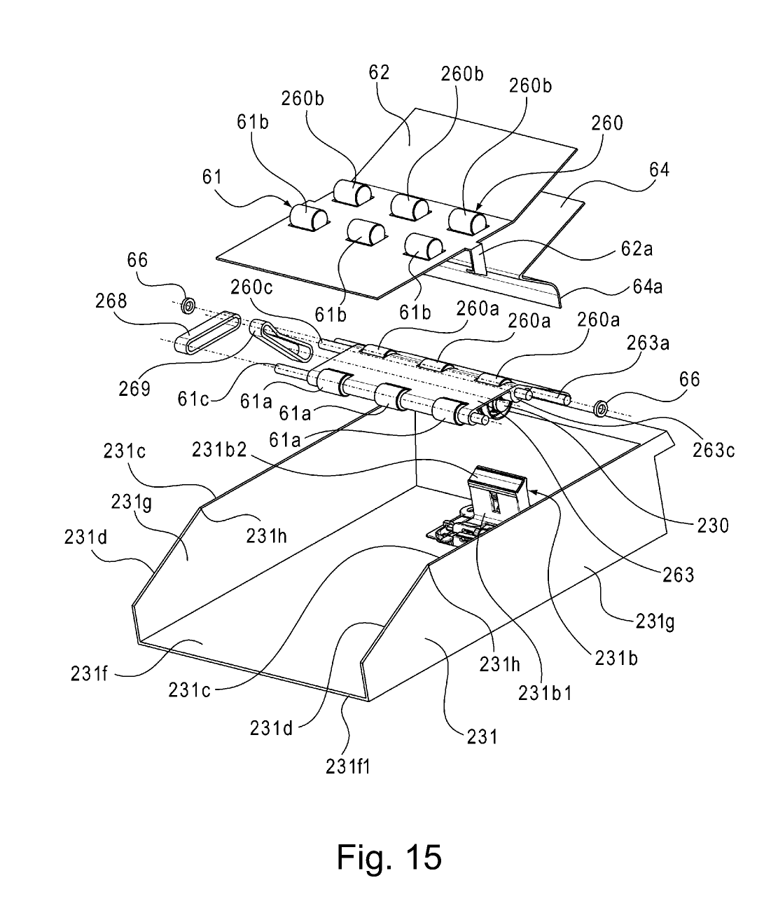

Next, referring to FIGS. 15-18, the image forming apparatus 1 in the third embodiment of the present invention is described about its structure. By the way, the members of the image forming apparatus 1 in this embodiment, and the portions thereof, which are similar in structure to the counterparts in each of the preceding embodiments, are given the same referential codes as the counterparts, and are not described. Further, in a case where a given member of the image forming apparatus 1 in this embodiment is different in referential code from the counterpart in each of the preceding embodiments, but, is similar in structure to the counterpart, it is not described.

### <Means for Rotationally Moving Bottom Guide>

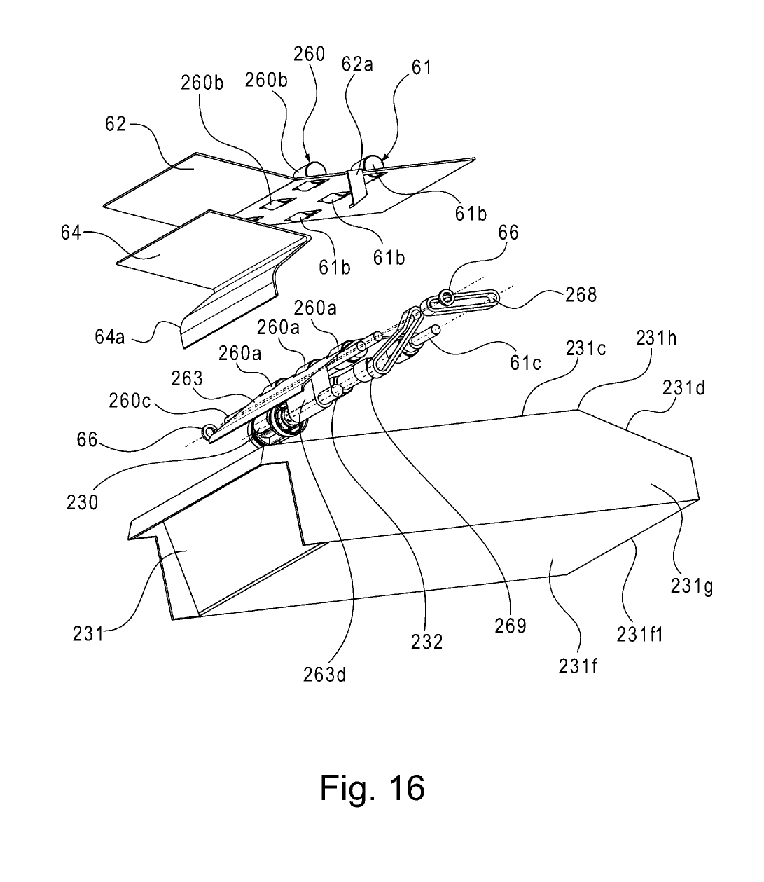

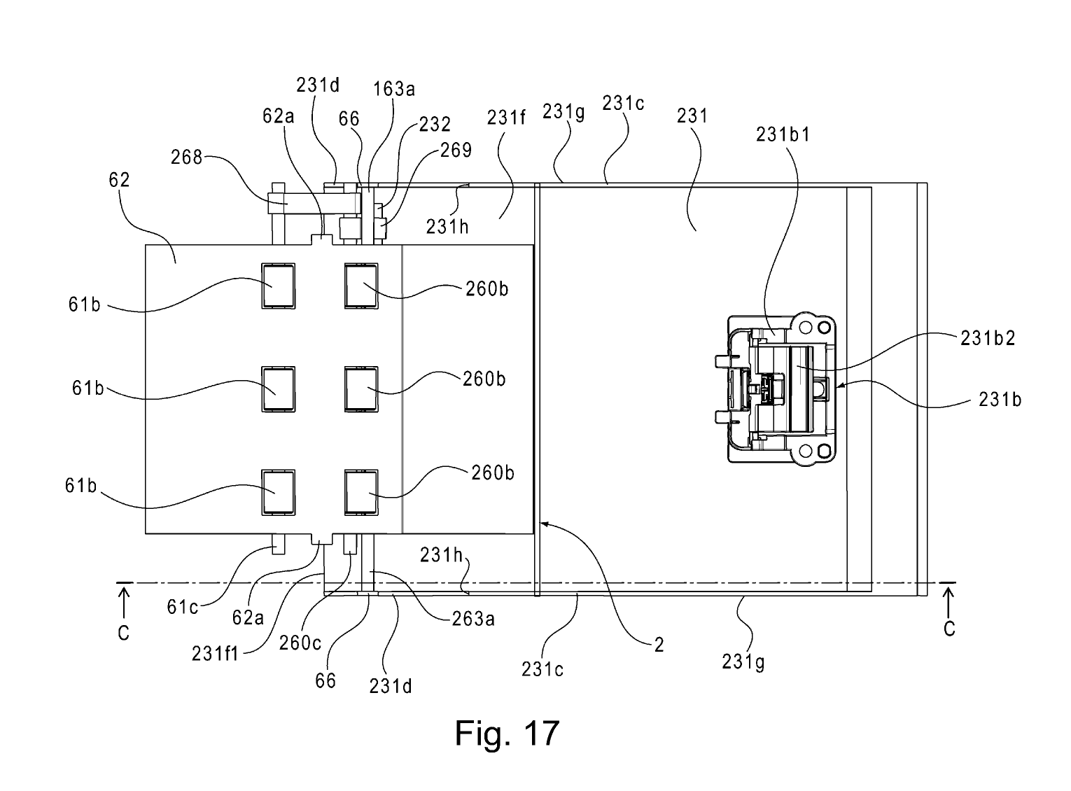

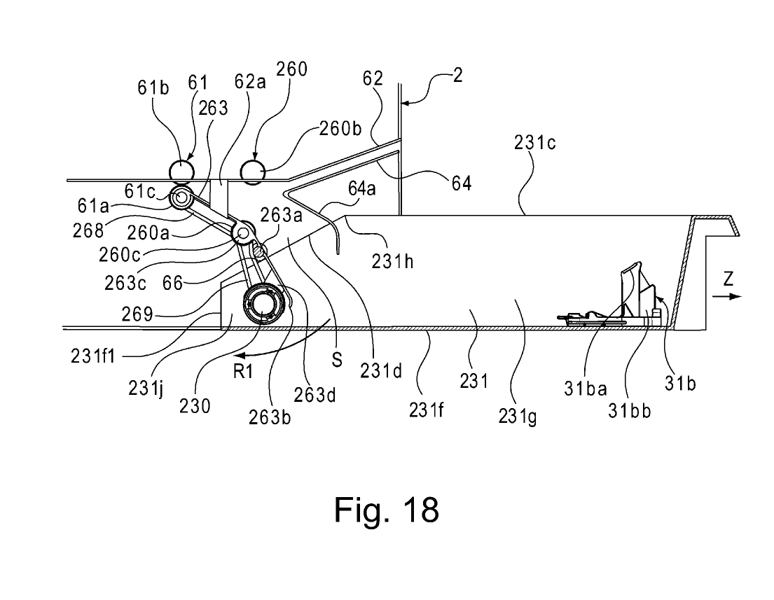

First, referring to FIGS. 15 and 16, the means, in this embodiment, for causing the bottom guide 263 to pivotally move is described about its structure. FIG. 15 is an exploded perspective view of a combination of a conveying portion 6 and a feeding-conveying cassette 231 in this embodiment, as seen from the top side of the combination, when the feeding-conveying cassette 231 is in its preset position (sheet feeding position) in the casing 2 of the main assembly of the image forming apparatus 1. It is for showing the structure of the means for causing the bottom guide 63 to pivotally move. FIG. 16 is an exploded perspective view of the combination of the conveying portion 6 and feeding-conveying cassette 231 in this embodiment, as seen from the bottom side of the combination, when the feeding-conveying cassette 31 is in its preset position (sheet feeding position) in the casing 2. It is for showing the structure of the means for causing the bottom guide 63 to pivotally move. FIG. 17 a top view of the combination when the bottom guide 263 is in its retraction position. It is for describing the structure of the means for causing the bottom guide 263 to pivotally move. FIG. 18 is a sectional view of the combination, at a plane C-C in FIG. 17, when the bottom guide 263 is in its retraction position.

In this embodiment, the rotational force of an unshown motor, as a driving force source, is transmitted to the rotational shaft 260c of the conveyance roller 260a by way of the rotational shaft 61c of the registration roller 61a and a driving belt 268. Further, the rotational driving force transmitted to the rotational shaft 260c is transmitted to the rotational shaft 232 of the feeding-conveying roller 230 by way of the driving belt 269.

Referring to FIG. 17, in terms of the widthwise direction of a sheet 7 of recording medium, the driving belt 268 is disposed on the outward side of the driving belt 269; the driving belt 269 is disposed on the inward side of the driving belt 268. The rotational driving force transmitted to the rotational shaft 61c of the registration roller 61a is transmitted to the rotational shaft 260c of the conveyance roller 260a by way of the driving belt 268. Further, the rotational driving force transmitted to the rotational shaft 260c is transmitted to the rotational shaft 232 of the feeding-conveying roller 230, shown in FIG. 16, by way of the driving belt 269. Thus, the registration roller 61a, conveyance roller 260a, and feeding-conveying roller 230 rotate together.

Also in this embodiment, in a case where it is necessary for the feeding-conveying cassette 231 (cassette) to be moved out of the casing 2, it is to be drawn by a user in the direction indicated by an arrow mark Z in FIG. 8 as the feeding-conveying cassette 31 is drawn by a user in the direction indicated by the arrow mark Z in the first embodiment described above. As the feeding-conveying cassette 231 is drawn, the bottom guide 263 is made to pivotally move in the direction indicated by an arrow mark R1 in FIG. 18 about the rotational shaft 61c of the registration roller 61a, by the combination of the means for causing the bottom guide 263 to pivotally move and the weight of the bottom guide 263, in such a manner that the front portion of the bottom guide 263 moves into the storing portion 231j which is in the inward adjacencies of the rear portion 231f1 of the feeding-conveying cassette 231 (cassette interior).

Also in the case of the mean for rotationally moving the bottom guide 263 in this embodiment, a pair of regulating rollers 66, which are regulating members, are rotatably supported by a pair of supporting shafts 263a, with which the edge portions of the bottom guide 263 in terms of its widthwise direction are provided one for one as the pair of regulating rollers 66 are rotatably supported by the pair of supporting shafts 63a in the first embodiment. Further, the horizontal guiding surface 231c, which is a part of the upwardly facing surface of each of the pair of lateral plates 231g of the feeding-conveying cassette 231 moves into a position in which it prevents the bottom guide 263 from rotationally moving. Further, the slant guiding surface 231d, which is another part of the upwardly facing surface of each of the pair of side plates 231g of the feeding-conveying cassette 231 allows the bottom guide 263 to rotationally move.

The image forming apparatus 1 is structured so that as the feeding-conveying cassette 231 (cassette) in the casing 2 is drawn by a user in the direction indicated by the arrow mark Z in FIG. 18, or the feeding-conveying cassette 231 is inserted into the casing 2 by the user in the opposite direction from the direction indicated by the arrow mark Z in FIG. 8, the pair of regulating rollers 66 (preventing members) rotate on the horizontal guiding surface 231c (preventing position) and then, on the slant guiding surface 231d as if they are running on the surfaces 231c or 231d in the direction indicated by the arrow mark Z in FIG. 18, or rotate on the slant guiding surface 231 (releasing position) and horizontal guiding surface 231c as if they are running on the surfaces 231d or 231c in the opposite direction from the direction indicated by the arrow mark Z in FIG. 18.

Thus, as the feeding-conveying cassette 231 (cassette) in its preset position (sheet feeding position) in casing 2 is drawn by a user in the direction indicated by the arrow mark Z in FIG. 18, the regulation roller 66 (preventing member) rotates on the horizontal guiding surface 231c (preventing position) as if it is running on the horizontal guiding surface 231c which is moving in the direction indicated by the arrow mark Z. Eventually, the border line 231h between the horizontal guiding surface 231c and slant guiding surface 231d moves past the regulating roller 66 (preventing member), and the slant guiding surface 231d comes into contact with the regulating roller 66. Thus, the bottom guide 263 is made to rotationally move by its own weight in the direction indicated by the arrow mark R1 in FIG. 18 about the rotational shaft 61c of the registration roller 61a, causing its front end portion to move into the storing portion 231j which is inward adjacencies of the rear portion 231f1 of the feeding-conveying cassette 131 (cassette interior).

When the regulation roller 66 rotates in contact with the horizontal guiding surface 231c or slant guiding surface 231d as if it is running on the two surfaces 231c or 231d, the bottom guide 263 remains pressed upon the two surfaces 231c or 231d, respectively, by its own weight. Also in this embodiment, the bottom guide 263 is provided with a bent portion 263b, like the bent portion 63b in the first embodiment, which is for causing a sheet 7 of recording medium to change in conveyance direction, in coordination with the top guide 64a of the front guide 64 as soon as the sheet 7 is fed into the main assembly of the image forming apparatus 1 from the feeding-conveying cassette 231 (cassette).

Further, referring to FIG. 8, the casing 2, top guide of the front guide 64 of the front guide 64 as a conveyance guide, and bottom guide 67 as a conveyance guide, are provided with slits (openings) 2a, 64b and 67a, respectively. Thus, the interior of the conveyance passage S through which a sheet of recording medium is conveyed is lit by the ambient light which enters the conveyance passage S through the slits 2a, 64b and 67a, making it easier for the user to see the interior of the conveyance passage S.

### <Action of Means for Rotationally Moving Bottom Guide>

Next, referring to FIGS. 17 and 18, the means for rotationally moving the bottom guide 263 is described about it action. Referring to FIG. 18, the bottom guide 263 rotatably supports the rotational shaft 260c of the conveyance roller 260a, and the rotational shaft feeding-conveying roller 230.

Referring to FIG. 18, when the bottom guide 263 is in its retraction position, the conveyance roller 260a, rotational shaft 260c of the conveyance roller 260a, feeding-conveying roller 230, and the rotational shaft 232 of the feeding-conveying roller 230 are in their retraction positions together.

Referring to FIG. 18, in this embodiment, as the feeding-conveying cassette 31 in the main assembly of the image forming apparatus 1 is drawn by a user in the direction indicated by the arrow mark Z in FIG. 18, not only the bottom guide 263, but also, the conveyance roller 260a, rotational shaft 260c of the conveyance roller 260a, feeding-conveying roller 230, and rotational shaft 232 of the feeding-conveying roller 230 move together into their retraction positions shown in FIG. 18.

Thus, the bottom guide 263 which includes the bent portion 263b which is a part of the conveyance passage S shown in FIG. 18 moves away from the top guide 62. Consequently, the conveyance passage S is exposed. Moreover, the conveyance roller 260a, rotational shaft 260c of the conveyance roller 260a, feeding-conveying roller 230, and rotational shaft 232 of the feeding-conveying roller 230 move away (retract) with the bottom guide 263 from their counterparts. Thus, the conveyance passage S is exposed.

Further, as the feeding-conveying cassette 231 in the casing 2 of the main assembly of the image forming apparatus 1 is drawn outward by a user, the bottom guide 263 having the bent portion 263b which is a part of the conveyance passage S into which a sheet 7 of recording medium is fed from the feeding-conveying cassette 231 rotationally moves in such a manner that its front portion moves into the storing portion 231j which is in the inward adjacencies of the rear portion 231f1 of the bottom plate 231f of the feeding-conveying cassette 231 (cassette interior).

The feeding-conveying cassette 231 in this embodiment has no rear plate; it is open at its rear end. Further, the conveyance roller 260a, the rotational shaft 260c of the conveyance roller 260a, feeding-conveying roller 230, and rotational shaft 232 of the feeding-conveying roller 230 are integral parts of the bottom guide 263. Thus, they move with the bottom guide 263 into the storing portion 231j which is in the inward adjacencies of the rear end portion 231f1 of the bottom plate 231f of the feeding-conveying cassette 231 (cassette interior).

Consequently, the entire range of the conveyance passage S in terms of the widthwise direction of a sheet 7 of recording medium is exposed. Thus, this embodiment is superior to each of the preceding embodiments in terms of the accessibility to the conveyance passage S from the underside of the passage S. That is, this embodiment makes it even easier for a user to remove a jammed sheet 7 of recording medium in the conveyance passage S having the bent portion which causes a sheet 7 of recording medium to U-turn (causes sheet 7 to move leftward in FIG. 1) as soon as the sheet 7 is fed into the conveyance passage S from the feeding-conveying cassette 231 than any of the preceding embodiments.

By the way, the separating portion 231b, separation pad holder 231b1, separation pad 231b2, bottom plate 231f, border line 231h, pair of conveyance roller 260, and conveyance roller 260b shown in FIGS. 15-18 correspond to the following members, one for one, in the first embodiment described above. That is, they correspond to the separating portion 31b, separation pad holder 31b1, separation pad 31b2, bottom plate 31f, border line 31h, pair of conveyance rollers 60, and conveyance roller 60b, respectively, in the first embodiment described above. Each of these members is similar in structure and effect as the counterpart in the first embodiment, and therefore, is not described. The other structural members in this embodiment are also similar in structure to the counterparts in each of the preceding embodiments, and can provide similar effects as those which can be provided by the counterparts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-085650 filed on Apr. 22, 2016, which is hereby incorporated by reference herein in its entirety.

What is claimed is:

1. An image forming apparatus comprising:
a casing;
a process unit detachably mounted to said casing, configured to form a developer image on a recording material and including a photosensitive member extending in a direction crossing with a vertical direction;
an exposing unit configured to expose said photosensitive member to light;
a cassette detachably mounted to said casing configured to accommodate the recording material to be fed to said process unit;
a feeding rotatable member configured to separate and feeding a single recording material from said cassette; and
a feeding guide provided in said casing and configured to guide the recording material moving from said cassette to said process unit,
wherein said exposing unit is disposed right above said feeding rotatable member in the vertical direction,
said process unit is disposed at a position which is substantially the same as said exposing unit in the vertical direction and which is downstream of said exposing unit in a horizontal direction, with respect to a feeding direction of the recording material,
said cassette is disposed below said feeding rotatable member in the vertical direction, and
said feeding guide is disposed between said exposing unit and said cassette in the vertical direction,
wherein said feeding guide includes an upper guide configured to guide an upper surface of the recording material and a lower guide configured to guide a lower surface of the recording material, and
wherein when said cassette is drawn out of said casing, said lower guide moves to an accommodating portion in said cassette.

2. An apparatus according to claim 1, further comprising a moving device configured to move said lower guide to said accommodating portion.

3. An apparatus according to claim 2, wherein said moving device includes a suppression member movable between a suppression position for suppressing movement of said lower guide and a release position for permitting movement of said lower guide, and wherein when said cassette is drawn out of said casing, said lower guide is moved to the accommodating portion by moving said suppression member to said release position.

4. An apparatus according to claim 1, wherein said moving device moves said lower guide to the accommodating portion in interrelation with said cassette being drawn out of said casing.

5. An apparatus according to claim 3, wherein said cassette is provided with a side surface plate having a horizontal guide surface and an inclined guide surface at a top portion of said side surface plate, wherein said lower guide is rotatable relative to said casing, and said suppression member is supported by said lower guide and movable relative to said horizontal guide surface and said inclined guide, and wherein said lower guide is rotated to the accommodating portion by said suppression member moving along said horizontal guide surface and said inclined guide surface in interrelation with said cassette being drawn out of said casing.

6. An apparatus according to claim 5, wherein said suppression member is provided with a regulation roller rotatably supported by said lower guide, and said regulation roller travels along said horizontal guide surface and said inclined guide surface in interrelation with said cassette being drawn out of said casing.

7. An apparatus according to claim 3, wherein said lower guide is rotatable relative to said casing, and said suppression member is rotatably supported by said lower guide and is provided with a regulating plate capable of being urged by a charging device to lock a locking portion with said casing, and wherein when an operating portion of said regulating plate is pushed against an urging force of said urging device, said locking portion is released from said casing to rotate said lower guide to the accommodating portion.

8. An apparatus according to claim 1, wherein said lower guide includes at least one of said feeding rotatable member and feeding rotatable member configured to feed the recording material from said feeding rotatable member to said process unit.

9. An apparatus according to claim 1, wherein said feeding guide is provided with a curved portion configured to change the feeding direction of the recording material fed from said cassette to an opposite direction.

10. An apparatus according to claim 1, wherein said casing and said feeding guide are provided with transparent light slits for easy observation of a feeding path of the recording material.
